(19) United States
(12) Patent Application Publication
(10) Pub. No.: US 2025/0338314 A1
(43) Pub. Date: Oct. 30, 2025

(54) METHOD FOR TRANSMITTING AND RECEIVING UPLINK SIGNAL AND/OR DOWNLINK SIGNAL, AND DEVICE FOR SAME

(71) Applicant: LG ELECTRONICS INC., Seoul (KR)

(72) Inventors: Sechang MYUNG, Seoul (KR); Seonwook KIM, Seoul (KR); Suckchel YANG, Seoul (KR)

(73) Assignee: LG ELECTRONICS INC., Seoul (KR)

(21) Appl. No.: 18/577,449

(22) PCT Filed: Aug. 1, 2022
(86) PCT No.: PCT/KR2022/011289

§ 371 Date: Jul. 24, 2024

(30) Foreign Application Priority Data
Aug. 5, 2021 (KR) 10-2021-0103459
Oct. 8, 2021 (KR) 10-2021-0133990

(51) Int. Cl. H04W 74/0833; H04W 74/00

(52) U.S. Cl. CPC H04W 74/0833; H04W 74/004

(57) ABSTRACT

Disclosed is a method for a terminal to transmit a first message of a random access procedure in a wireless communication system. In particular, the method comprises the steps of: receiving first information related to the configuration of the random access procedure; acquiring, on the basis of the first information, second information related to a plurality of transmission occasions for transmitting the first message; determining an observation period on the basis of reference points related to the observation period; and transmitting the first message without channel sensing through a transmission occasion, included in a period corresponding to the duty cycle of the observation period, among the plurality of transmission occasions, wherein the reference points can be configured on the basis of a specific system frame number (SFN) or a specific slot.

### TECHNICAL FIELD

The present disclosure relates to a method of transmitting and receiving uplink and/or downlink signals and device therefor, and more particularly, to a method of determining/configuring the operation mode and/or type of listen before talk (LBT) for transmitting and receiving uplink and/or downlink signals and device therefor.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### DISCLOSURE

### Technical Problem

The present disclosure aims to provide a method of transmitting and receiving uplink and/or downlink signals and device therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, provided herein is a method of transmitting by a user equipment (UE) a first message of a random access procedure in a wireless communication system. The method may include: receiving first information regarding a configuration of the random access procedure; obtaining second information regarding a plurality of transmission occasions for transmission of the first message based on the first information; determining an observation period based on a reference point related to the observation period; and transmitting the first message on a transmission occasion within a period corresponding to a duty cycle of the observation period among the plurality of transmission occasions without channel sensing. The reference point may be configured based on a specific system frame number (SFN) or a specific slot.

In this case, based on that all of the plurality of transmission occasions within the observation period are included in the duty cycle, the first message may be transmitted without the channel sensing.

Additionally, based on that the transmission occasion for the first message is not included in the duty cycle, the first message may be transmitted after performing the channel sensing.

Additionally, based on that information regarding the reference point is not received, the reference point may be set to an SFN with index 0.

Additionally, based on that the transmission occasion for the first message is not included in the duty cycle, the transmission of the first message may be dropped.

Additionally, the first message may be a message 1 (Msg 1) or a message A (Msg A). The transmission occasion may be a random access channel (RACH) occasion for the Msg 1, a RACH occasion for the Msg A, or a physical uplink shared channel (PUSCH) occasion for the Msg A.

In another aspect of the present disclosure, provided herein is a UE configured to transmit a first message of a random access procedure in a wireless communication system. The UE may include: at least one transceiver; at least one processor; and at least one memory operably connected to the at least one processor and configured to store instructions that, when executed, cause the at least one processor to perform operations. The operations may include: receiving first information regarding a configuration of the random access procedure through the at least one transceiver; obtaining second information regarding a plurality of transmission occasions for transmission of the first message based on the first information; determining an observation period based on a reference point related to the observation period; and transmitting the first message on a transmission occasion within a period corresponding to a duty cycle of the observation period among the plurality of transmission occasions through the at least one transceiver without channel sensing. The reference point may be configured based on a specific SFN or a specific slot.

In this case, based on that all of the plurality of transmission occasions within the observation period are included in the duty cycle, the first message may be transmitted without the channel sensing.

Additionally, based on that the transmission occasion for the first message is not included in the duty cycle, the first message may be transmitted after performing the channel sensing.

Additionally, based on that information regarding the reference point is not received, the reference point may be set to an SFN with index 0.

Additionally, based on that the transmission occasion for the first message is not included in the duty cycle, the transmission of the first message may be dropped.

Additionally, the first message may be a message 1 (Msg 1) or a message A (Msg A). The transmission occasion may be a random access channel (RACH) occasion for the Msg 1, a RACH occasion for the Msg A, or a physical uplink shared channel (PUSCH) occasion for the Msg A.

In another aspect of the present disclosure, provided herein is an apparatus configured to transmit a first message of a random access procedure in a wireless communication system. The apparatus may include: at least one processor; and at least one memory operably connected to the at least one processor and configured to store instructions that, when executed, cause the at least one processor to perform operations. The operations may include: receiving first information regarding a configuration of the random access procedure; obtaining second information regarding a plurality of transmission occasions for transmission of the first message based on the first information; determining an observation period based on a reference point related to the observation period; and transmitting the first message on a transmission occasion within a period corresponding to a duty cycle of the observation period among the plurality of transmission occasions without channel sensing. The reference point may be configured based on a specific SFN or a specific slot.

In a further aspect of the present disclosure, provided herein is a computer-readable storage medium comprising at least one computer program that causes at least one processor to perform operations. The operations may include: receiving first information regarding a configuration of the random access procedure; obtaining second information regarding a plurality of transmission occasions for transmission of the first message based on the first information; determining an observation period based on a reference point related to the observation period; and transmitting the first message on a transmission occasion within a period corresponding to a duty cycle of the observation period among the plurality of transmission occasions without channel sensing. The reference point may be configured based on a specific SFN or a specific slot.

### Advantageous Effects

According to [Proposed Method #1] of the present disclosure, in high interference situations, a user equipment (UE) configured/indicated with a no listen before talk (no-LBT) mode as the channel access mode may switch an LBT operation mode and perform a channel access procedure based on an LBT mode, thereby reducing the probability of transmission collision. When low interference is expected, the UE may perform efficient transmission by quickly performing channel access in the no-LBT mode (i.e., starting transmission immediately without LBT).

According to [Proposed Method #2] of the present disclosure, the reference point of an observation period for checking a duty cycle check may be configured together with random access channel (RACH) configurations. Thus, a UE may check whether short control signalling exemption (SCSe) is applicable to message 1 (Msg1) and/or message A (MsgA). The UE may transmit Msg1/MsgA without LBT if the duty cycle is satisfied. Accordingly, the UE may rapidly perform a RACH procedure with no errors in countries/regions where the implementation of a spectrum sharing mechanism such as LBT is mandatory for unlicensed band operation.

According to [Proposed Method #3] of the present disclosure, when a base station (BS) or UE operates in the LBT mode, the BS or UE may obtain a channel occupancy time (COT) (e.g., maximum channel occupancy time (MCOT)=5 ms) if random backoff-based LBT (e.g., Cat-3 LBT or Cat-4 LBT) is successful. The BS or UE may perform COT sharing by applying appropriate LBT depending on the gap between transmissions within the COT. In other words, the BS or UE may limit the length of subsequent transmission or allow DL/UL switching to be performed multiple times, depending on the gap between transmissions (i.e., gap required for DL-to-UL or UL-to-DL switching) and the presence of additional LBT, thereby efficiently performing COT sharing.

According to [Proposed Method #3] of the present disclosure, when an uplink signal is transmitted, the applicability of SCSe and LBT operation mode may be configured together depending on the type of the corresponding uplink signal. Even in countries/regions where it is mandatory to implement a spectrum sharing mechanism such as LBT for unlicensed band operation, a UL signal may be transmitted and received efficiently with no errors.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates an exemplary wireless communication system supporting an unlicensed band applicable to the present disclosure.

FIG. 2 illustrates an exemplary method of occupying resources in an unlicensed band applicable to the present disclosure.

FIG. 3 illustrates an example of a channel access procedure of a user equipment (UE) for uplink/downlink signal transmission in an unlicensed band applicable to the present disclosure.

FIG. 4 is a diagram for explaining a plurality of listen before talk subbands (LBT-SBs) applicable to the present disclosure.

FIG. 5 is a diagram illustrating an exemplary 4-step RACH procedure.

FIG. 6 is a diagram illustrating an exemplary 2-step RACH procedure.

FIG. 7 is a diagram illustrating a contention-free RACH procedure.

FIGS. 8 and 9 are diagrams illustrating transmission of SSBs and PRACH resources linked to the SSBs according to various embodiments of the present disclosure.

FIG. 10 is a diagram for explaining short control signaling exemption (SCSe) transmission.

FIG. 11 is a diagram for explaining issues that occur in performing directional LBT (D-LBT) according to embodiments of the present disclosure.

FIGS. 12 to 14 are diagrams illustrating overall operation processes of a user equipment (UE) and a base station (BS) according to embodiments of the present disclosure.

FIG. 15 is a diagram illustrating a method by which a UE transmits message 1 (Msg 1) or message A (Msg A) according to embodiments of the present disclosure.

FIG. 16 illustrates an exemplary communication system applied to the present disclosure.

FIG. 17 illustrates exemplary wireless devices applicable to the present disclosure.

FIG. 18 illustrates an exemplary vehicle or autonomous driving vehicle applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (cMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information regarding top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

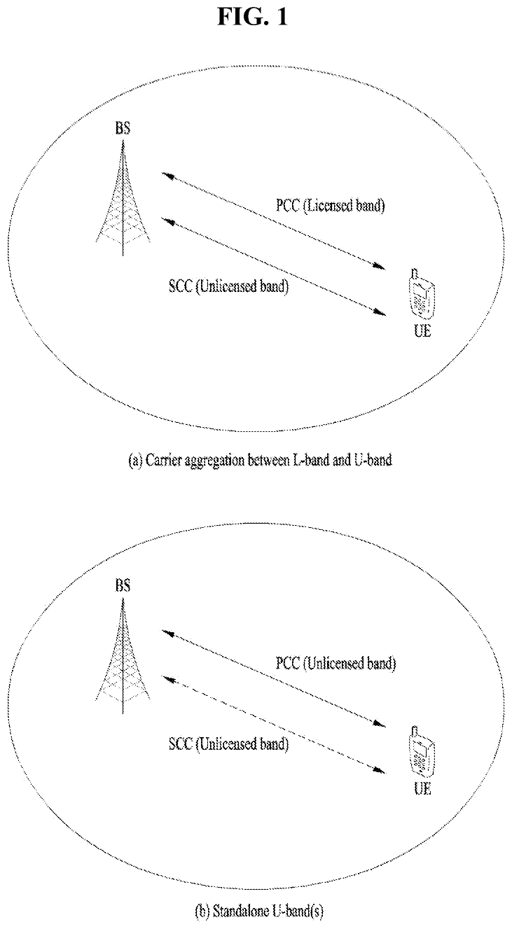

FIG. 1 illustrates an exemplary wireless communication system supporting an unlicensed band applicable to the present disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on carrier-aggregated LCC and UCC as illustrated in FIG. 1(a), the LCC and the UCC may be configured as a primary CC (PCC) and a secondary CC (SCC), respectively. The BS and the UE may transmit and receive signals on one UCC or on a plurality of carrier-aggregated UCCs as illustrated in FIG. 7(b). In other words, the BS and UE may transmit and receive signals only on UCC(s) without using any LCC. For an SA operation, PRACH, PUCCH, PUSCH, and SRS transmissions may be supported on a UCell.

Signal transmission and reception operations in a U-band as described in the present disclosure may be applied to the afore-mentioned deployment scenarios (unless specified otherwise).

Unless otherwise noted, the definitions below are applicable to the following terminologies used in the present disclosure.
Channel: a carrier or a part of a carrier composed of a contiguous set of RBs in which a channel access procedure (CAP) is performed in a shared spectrum.
Channel access procedure (CAP): a procedure of assessing channel availability based on sensing before signal transmission in order to determine whether other communication node(s) are using a channel. A basic sensing unit is a sensing slot with a duration of Tsl=9 μs. The BS or the UE senses the slot during a sensing slot duration. When power detected for at least 4 us within the sensing slot duration is less than an energy detection threshold Xthresh, the sensing slot duration Tsl is be considered to be idle. Otherwise, the sensing slot duration Tsl is considered to be busy. CAP may also be called listen before talk (LBT).
Channel occupancy: transmission(s) on channel(s) from the BS/UE after a CAP.
Channel occupancy time (COT): a total time during which the BS/UE and any BS/UE(s) sharing channel occupancy performs transmission(s) on a channel after a CAP. Regarding COT determination, if a transmission gap is less than or equal to 25 μs, the gap duration may be counted in a COT.

The COT may be shared for transmission between the BS and corresponding UE(s).

Specifically, sharing a UE-initiated COT with the BS may mean an operation in which the UE assigns a part of occupied channels through random backoff-based LBT (e.g., Category 3 (Cat-3) LBT or Category 4 (Cat-4) LBT) to the BS and the BS performs DL transmission using a remaining COT of the UE, when it is confirmed that a channel is idle by success of LBT after performing LBT without random backoff (e.g., Category 1 (Cat-1) LBT or Category 2 (Cat-2) LBT) using a timing gap occurring before DL transmission start from a UL transmission end timing of the UE.

Meanwhile, sharing a gNB-initiated COT with the UE may mean an operation in which the BS assigns a part of occupied channels through random backoff-based LBT (e.g., Cat-3 LBT or Cat-4 LBT) to the UE and the UE performs UL transmission using a remaining COT of the BS, when it is confirmed that a channel is idle by success of LBT after performing LBT without random backoff (e.g., Cat-1 LBT or Cat-2 LBT) using a timing gap occurring before UL transmission start from a DL transmission end timing of the BS.
DL transmission burst: a set of transmissions without any gap greater than 16 us from the BS. Transmissions from the BS, which are separated by a gap exceeding 16 us are considered as separate DL transmission bursts. The BS may perform transmission(s) after a gap without sensing channel availability within a DL transmission burst.
UL transmission burst: a set of transmissions without any gap greater than 16 us from the UE. Transmissions from the UE, which are separated by a gap exceeding 16 us are considered as separate UL transmission bursts. The UE may perform transmission(s) after a gap without sensing channel availability within a DL transmission burst.
Discovery burst: a DL transmission burst including a set of signal(s) and/or channel(s) confined within a window and associated with a duty cycle. The discovery burst may include transmission(s) initiated by the BS, which includes a PSS, an SSS, and a cell-specific RS (CRS) and further includes a non-zero power CSI-RS. In the NR system, the discover burst includes may include transmission(s) initiated by the BS, which includes at least an SS/PBCH block and further includes a CORESET for a PDCCH scheduling a PDSCH carrying SIB1, the PDSCH carrying SIB1, and/or a non-zero power CSI-RS.

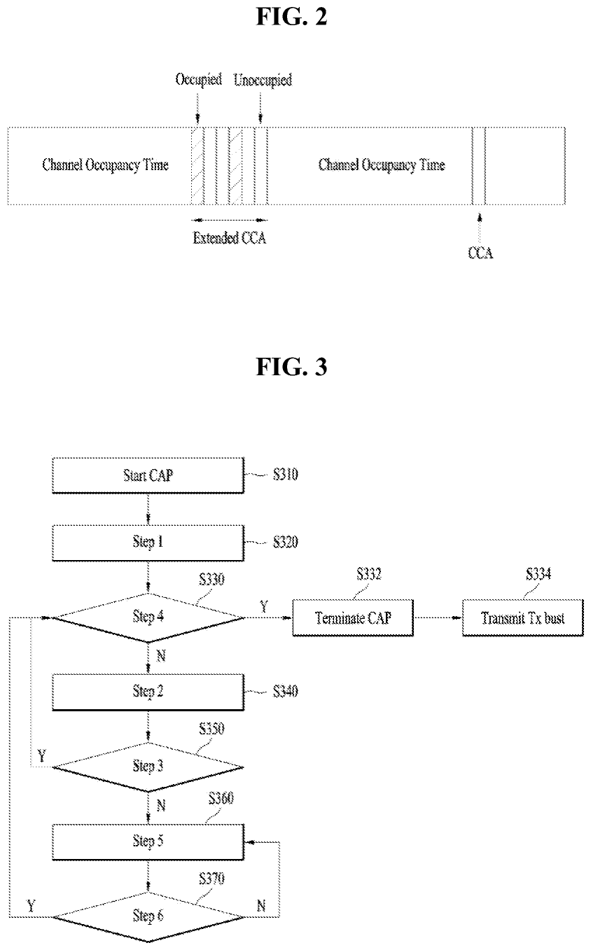

FIG. 2 illustrates an exemplary method of occupying resources in a U-band.

Referring to FIG. 2, a communication node (e.g., a BS or a UE) operating in a U-band should determine whether other communication node(s) is using a channel, before signal transmission. For this purpose, the communication node may perform a CAP to access channel(s) on which transmission(s) is to be performed in the U-band. The CAP may be performed based on sensing. For example, the communication node may determine whether other communication node(s) is transmitting a signal on the channel(s) by carrier sensing (CS) before signal transmission. Determining that other communication node(s) is not transmitting a signal is defined as confirmation of clear channel assessment (CCA). In the presence of a CCA threshold (e.g., Xthresh) which has been predefined or configured by higher-layer (e.g., RRC) signaling, the communication node may determine that the channel is busy, when detecting energy higher than the CCA threshold in the channel. Otherwise, the communication node may determine that the channel is idle. When determining that the channel is idle, the communication node may start to transmit a signal in the U-band. CAP may be replaced with LBT.

Table 1 describes an exemplary CAP supported in NR-U.

TABLE 1

| | Type | Explanation |
|---|---|---|
| DL | Type 1 CAP | CAP with random back-off |
| | | time duration spanned by the sensing slots that |
| | | are sensed to be idle before a downlink |
| | | transmission(s) is random |
| | Type 2 CAP | CAP without random back-off |
| | Type 2A, | time duration spanned by sensing slots that are |
| | 2B, 2C | sensed to be idle before a downlink transmission(s) |
| | | is deterministic |
| UL | Type 1 CAP | CAP with random back-off |
| | | time duration spanned by the sensing slots that |
| | | are sensed to be idle before a downlink |
| | | transmission(s) is random |
| | Type 2 CAP | CAP without random back-off |
| | Type 2A, | time duration spanned by sensing slots that are |
| | 2B, 2C | sensed to be idle before a downlink transmission(s) |
| | | is deterministic |

In a wireless communication system supporting a U-band, one cell (or carrier (e.g., CC)) or BWP configured for a UE may be a wideband having a larger bandwidth (BW) than in legacy LTE. However, a BW requiring CCA based on an independent LBT operation may be limited according to regulations. Let a subband (SB) in which LBT is individually performed be defined as an LBT-SB. Then, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information. A plurality of LBT-SBs may be included in the BWP of a cell (or carrier). An LBT-SB may be, for example, a 20-MHz band. The LBT-SB may include a plurality of contiguous (P) RBs in the frequency domain, and thus may be referred to as a (P) RB set.

In Europe, two LBT operations are defined: frame based equipment (FBE) and load based equipment (LBE). In FBE, one fixed frame is composed of a COT (e.g., 1 to 10 ms), which refers to a time period during which a communication node is capable of sustaining transmission after successfully connecting to a channel, and an idle period corresponding to a minimum of 5% of the COT. In addition, CCA is defined as an operation of observing a channel during a CCA slot (at least 20 μs) at the end of the idle period. The communication node performs CCA periodically on a fixed frame basis. When the channel is unoccupied, the communication node transmits during the COT, whereas when the channel is occupied, the communication node defers the transmission and waits until a CCA slot in the next period.

In LBE, the communication node may set a value of q, where q∈{4, 5, . . . , 32} and then perform CCA for one CCA slot. When the channel is unoccupied in the first CCA slot, the communication node may secure a time period of up to (13/32) q ms and transmit data in the time period. When the channel is occupied in the first CCA slot, the communication node randomly selects a value of N, where N∈{1, 2, . . . , q}, stores the selected value as an initial value, and then senses a channel state on a CCA slot basis. Each time the channel is unoccupied in a CCA slot, the communication node decrements the stored counter value by 1. When the counter value reaches 0, the communication node may secure a time period of up to (13/32) q ms and transmit data.

In the LTE/NR system, the eNB/gNB or UE needs to perform LBT to transmit a signal in an unlicensed band (hereinafter U-band). In addition, when the CNB or UE in the LTE/NR system performs signal transmission, other communication nodes such as a Wi-Fi node, etc. need to perform the LBT to avoid causing interference to the eNB or UE. For example, in Wi-Fi specifications (801.11ac), a CCA threshold of −62 dBm is defined for non-Wi-Fi signals, and a CCA threshold of −82 dBm is defined for Wi-Fi signals. That is, when a station (STA) or an access point (AP) receives a non-Wi-Fi signal with power over −62 dBm, the STA or AP may not perform signal transmission to avoid causing interference.

A UE performs a Type 1 or Type 2 CAP for a UL signal transmission in a U-band. In general, the UE may perform a CAP (e.g., Type 1 or Type 2) configured by a BS, for a UL signal transmission. For example, CAP type indication information may be included in a UL grant (e.g., DCI format 0_0 or DCI format 0_1) that schedules a PUSCH transmission.

In the Type 1 UL CAP, the length of a time period spanned by sensing slots sensed as idle before transmission(s) is random. The Type 1 UL CAP may be applied to the following transmissions.
PUSCH/SRS transmission(s) scheduled and/or configured by BS
PUCCH transmission(s) scheduled and/or configured by BS
Transmission(s) related to random access procedure (RAP)

FIG. 3 illustrates Type 1 CAP among channel access procedures of a UE for UL/DL signal transmission in a U-band applicable to the present disclosure.

First, UL signal transmission in the U-band will be described with reference to FIG. 3.

The UE may sense whether a channel is idle for a sensing slot duration in a defer duration Td. After a counter N is decremented to 0, the UE may perform a transmission (S1634). The counter N is adjusted by sensing the channel for additional slot duration(s) according to the following procedure.

Step 1) Set N=Ninit where Ninit is a random number uniformly distributed between 0 and CWp, and go to step 4 (S320).

Step 2) If N>0 and the UE chooses to decrement the counter, set N=N−1 (S340).

Step 3) Sense the channel for an additional slot duration, and if the additional slot duration is idle (Y), go to step 4. Else (N), go to step 5 (S350).

Step 4) If N=0 (Y) (S330), stop CAP (S332). Else (N), go to step 2.

Step 5) Sense the channel until a busy sensing slot is detected within the additional defer duration Td or all slots of the additional defer duration Td are sensed as idle (S360).

Step 6) If the channel is sensed as idle for all slot durations of the additional defer duration Td (Y), go to step 4. Else (N), go to step 5 (S370).

Table 2 illustrates that mp, a minimum CW, a maximum CW, a maximum channel occupancy time (MCOT), and an allowed CW size applied to a CAP vary according to channel access priority classes.

TABLE 2

| Channel | | | | | |
|---|---|---|---|---|---|
| Access | | | | | |
| Priority | | | | | |
| Class | | CWmin, | CWma | Tulmcot, | |
| (p) | mp | p | x, p | p | allowed CWp sizes |
| 1 | 2 | 3 | 7 | 2 ms | {3, 7} |
| 2 | 2 | 7 | 15 | 4 ms | {7, 15} |
| 3 | 3 | 15 | 1023 | 6 or 10 ms | {15, 31, 63, 127, 255, |
| | | | | | 511, 1023} |
| 4 | 7 | 15 | 1023 | 6 or 10 ms | {15, 31, 63, 127, 255, |
| | | | | | 511, 1023} |

The defer duration Td includes a duration Tf (16 μs) immediately followed by mp consecutive slot durations where each slot duration Tsl is 9 μs, and Tf includes a sensing slot duration Tsl at the start of the 16-μs duration. CWWmin,p<=CWp<=CWmax,p. CWp is set to CWmin,p, and may be updated before Step 1 based on an explicit/implicit reception response to a previous UL burst (e.g., PUSCH) (CW size update). For example, CWp may be initialized to CWmin,p based on an explicit/implicit reception response to the previous UL burst, may be increased to the next higher allowed value, or may be maintained to be an existing value.

In the Type 2 UL CAP, the length of a time period spanned by sensing slots sensed as idle before transmission(s) is deterministic. Type 2 UL CAPs are classified into Type 2A UL CAP, Type 2B UL CAP, and Type 2C UL CAP. In the Type 2A UL CAP, the UE may transmit a signal immediately after the channel is sensed as idle during at least a sensing duration Tshort_dl (=25 μs). Tshort_dl includes a duration Tf (=16 μs) and one immediately following sensing slot duration. In the Type 2A UL CAP, Tf includes a sensing slot at the start of the duration. In the Type 2B UL CAP, the UE may transmit a signal immediately after the channel is sensed as idle during a sensing slot duration Tf (=16 μs). In the Type 2B UL CAP, Tf includes a sensing slot within the last 9 μs of the duration. In the Type 2C UL CAP, the UE does not sense a channel before a transmission.

To allow the UE to transmit UL data in the U-band, the BS should succeed in an LBT operation to transmit a UL grant in the U-band, and the UE should also succeed in an LBT operation to transmit the UL data. That is, only when both of the BS and the UE succeed in their LBT operations, the UE may attempt the UL data transmission. Further, because a delay of at least 4 msec is involved between a UL grant and scheduled UL data in the LTE system, earlier access from another transmission node coexisting in the U-band during the time period may defer the scheduled UL data transmission of the UE. In this context, a method of increasing the efficiency of UL data transmission in the U-band is under discussion.

To support a UL transmission having a relatively high reliability and a relatively low time delay, NR also supports CG type 1 and CG type 2 in which the BS preconfigures time, frequency, and code resources for the UE by higher-layer signaling (e.g., RRC signaling) or both of higher-layer signaling and L1 signaling (e.g., DCI). Without receiving a UL grant from the BS, the UE may perform a UL transmission in resources configured with type 1 or type 2. In type 1, the periodicity of a CG, an offset from SFN=0, time/frequency resource allocation, a repetition number, a DMRS parameter, an MCS/TB size (TBS), a power control parameter, and so on are all configured only by higher-layer signaling such as RRC signaling, without L1 signaling. Type 2 is a scheme of configuring the periodicity of a CG and a power control parameter by higher-layer signaling such as RRC signaling and indicating information about the remaining resources (e.g., the offset of an initial transmission timing, time/frequency resource allocation, a DMRS parameter, and an MCS/TBS) by activation DCI as L1 signaling.

A largest difference between the AUL of the LTE LAA and the configured grant of the NR is a method of transmitting HARQ-ACK feedback for the PUSCH transmitted by the UE without a UL grant and presence or absence of UCI transmitted together when the PUSCH is transmitted. In the NR Configured grant, the HARQ process is determined using an equation of a symbol index, a period, and the number of HARQ processes, but in the LTE LAA, explicit HARQ-ACK feedback information is transmitted through AUL-downlink feedback information (DFI). In the LTE LAA, whenever the AUL PUSCH is transmitted, UCI containing information such as HARQ ID, NDI, or RV is also transmitted through the AUL-UCI. In the NR configured grant, the UE is identified by the time/frequency resources and DMRS resources used by the UE for PUSCH transmission, and in the LTE LAA, the UE is identified by the UE ID explicitly included in the AUL-UCI transmitted along with the PUSCH in addition to the DMRS resources.

In a wireless communication system supporting a U-band, one cell (or carrier (e.g., CC)) or BWP configured for the UE may consist of a wideband having a larger BW than in legacy LTE. However, a BW requiring CCA based on an independent LBT operation may be limited according to regulations. If a subband (SB) in which LBT is individually performed is defined as an LBT-SB, a plurality of LBT-SBs may be included in one wideband cell/BWP. A set of RBs constituting an LBT-SB may be configured by higher-layer (e.g., RRC) signaling. Accordingly, one or more LBT-SBs may be included in one cell/BWP based on (i) the BW of the cell/BWP and (ii) RB set allocation information.

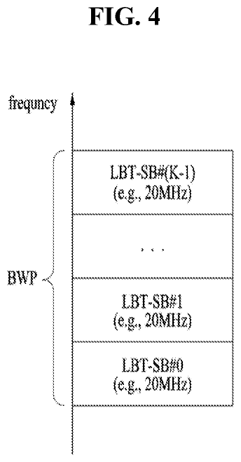

FIG. 4 illustrates that a plurality of LBT-SBs is included in a U-band.

Referring to FIG. 4, a plurality of LBT-SBs may be included in the BWP of a cell (or carrier). An LBT-SB may be, for example, a 20-MHz band. The LBT-SB may include a plurality of contiguous (P) RBs in the frequency domain and thus may be referred to as a (P) RB set. Although not illustrated, a guard band (GB) may be included between the LBT-SBs. Therefore, the BWP may be configured in the form of {LBT-SB #0 (RB set #0)+GB #0+LBT-SB #1 (RB set #1+GB #1)+ . . . +LBT-SB #(K−1) (RB set (#K−1))}. For convenience, LBT-SB/RB indexes may be configured/defined to be increased as a frequency band becomes higher starting from a low frequency band.

### Random Access (RACH) Procedure

When a UE initially accesses a BS or has no radio resources for signal transmission, the UE may perform a random access procedure with the BS.

The random access procedure is used for various purposes. For example, the random access procedure may be used for initial network access in the RRC_IDLE state, an RRC connection reestablishment procedure, handover, UE-triggered UL data transmission, transition from the RRC_INACTIVE state, time alignment establishment in SCell addition, other system information (OSI) request, and beam failure recovery. The UE may acquire UL synchronization and UL transmission resources in the random access procedure.

Random access procedures may be classified into a contention-based random access procedure and a contention-free random access procedure. The contention-based random access procedure is further branched into a 4-step random access (RACH) procedure and a 2-step random access (RACH) procedure.

### (1) 4-Step RACH: Type-1 Random Access Procedure

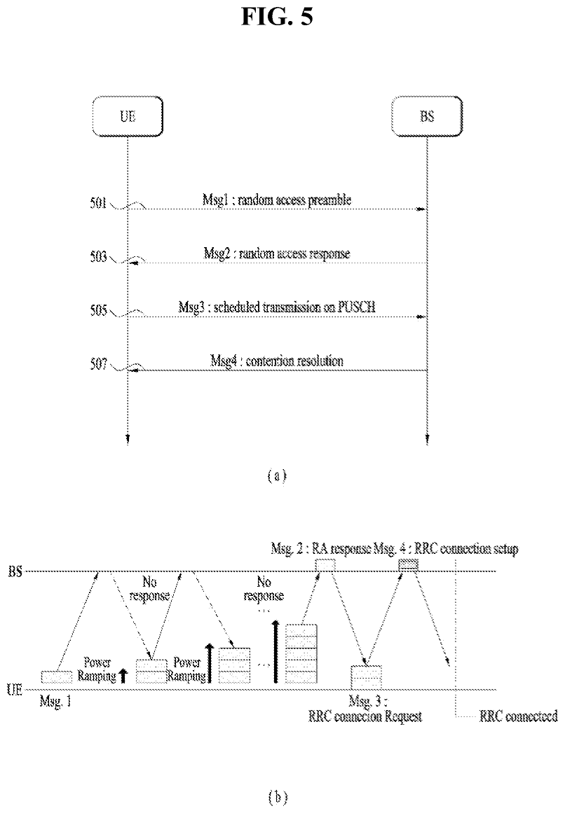

FIG. 5 is a diagram illustrating an exemplary 4-step RACH procedure.

When the (contention-based) random access procedure is performed in four steps (4-step RACH procedure), the UE may transmit a message (Message 1 or Msg1) including a preamble related to a specific sequence on a physical random access channel (PRACH) (501) and receive a PDCCH and a response message (random access response (RAR) message) (Message 2 or Msg2) for the preamble on a PDSCH corresponding to the PDCCH (503). The UE transmits a message (Message 3 or Msg3) including a PUSCH based on scheduling information included in the RAR (505) and perform a contention resolution procedure involving reception of a PDCCH signal and a PDSCH signal corresponding to the PDCCH signal. The UE may receive a message (Message 4 or Msg4) including contention resolution information for the contention resolution procedure from the BS (507).

The 4-step RACH procedure of the UE may be summarized in Table 3 below.

TABLE 3

| | Type of Signals | Operations/Information obtained |
|---|---|---|
| 1^{st} step | PRACH preamble in UL | Initial beam obtainment |
| | | Random selection of RA-preamble ID |
| 2^{nd} step | Random Access | Timing Advanced information |
| | Response on DL-SCH | RA-preamble ID |
| | | Initial UL grant, Temporary C-RNTI |
| 3^{rd} step | UL transmission | RRC connection request |
| | on UL-SCH | UE identifier |
| 4^{th} step | Contention Resolution | Temporary C-RNTI on PDCCH for |
| | on DL | initial access C-RNTI on PDCCH for |
| | | UE in RRC_CONNECTED |

In a random access procedure, the UE may first transmit an RACH preamble as Msg1 on a PRACH.

Random access preamble sequences of two different lengths are supported. The longer sequence length 839 is applied to the SCSs of 1.25 kHz and 5 kHz, whereas the shorter sequence length 139 is applied to the SCSs of 15 kHz, 30 kHz, 60 kHz, and 120 KHz.

Multiple preamble formats are defined by one or more RACH OFDM symbols and different cyclic prefixes (CPs) (and/or guard times). An RACH configuration for the initial bandwidth of a primary cell (PCell) is provided in system information of the cell to the UE. The RACH configuration includes information about a PRACH SCS, available preambles, and a preamble format. The RACH configuration includes information about associations between SSBs and RACH (time-frequency) resources. The UE transmits an RACH preamble in RACH time-frequency resources associated with a detected or selected SSB.

An SSB threshold for RACH resource association may be configured by the network, and an RACH preamble is transmitted or retransmitted based on an SSB having a reference signal received power (RSRP) measurement satisfying the threshold. For example, the UE may select one of SSBs satisfying the threshold, and transmit or retransmit the RACH preamble in RACH resources associated with the selected SSB. For example, when retransmitting the RACH preamble, the UE may reselect one of the SSBs and retransmit the RACH preamble in RACH resources associated with the reselected SSB. That is, the RACH resources for the retransmission of the RACH preamble may be identical to and/or different from the RACH resources for the transmission of the RACH preamble.

Upon receipt of the RACH preamble from the UE, the BS transmits an RAR message (Msg2) to the UE. A PDCCH that schedules a PDSCH carrying the RAR is cyclic redundancy check (CRC)-masked by a random access radio network temporary identifier (RA-RNTI) and transmitted. Upon detection of the PDCCH masked by the RA-RNTI, the UE may receive the RAR on the PDSCH scheduled by DCI carried on the PDCCH. The UE determines whether the RAR includes RAR information for its transmitted preamble, that is, Msg1. The UE may make the determination by checking the presence or absence of the RACH preamble ID of its transmitted preamble in the RAR. In the absence of the response to Msg1, the UE may retransmit the RACH preamble a predetermined number of or fewer times, while performing power ramping. The UE calculates PRACH transmission power for the preamble retransmission based on the latest transmission power, a power increment, and a power ramping counter.

The RAR information may include the preamble sequence transmitted by the UE, a temporary cell RNTI (TC-RNTI) that the BS has allocated to the UE attempting random access, UL transmit time alignment information, UL transmission power adjustment information, and UL radio resource allocation information. Upon receipt of its RAR information regarding a PDSCH, the UE may acquire time advance information for UL synchronization, an initial UL grant, and a TC-RNTI. The timing advance information is used to control a UL signal transmission timing. For better alignment between a PUSCH/PUCCH transmission of the UE and a subframe timing of a network end, the network (e.g., the BS) may acquire timing advance information based on timing information detected from the PRACH preamble received from the UE and transmit the timing advance information. The UE may transmit a UL signal as Msg3 of the random access procedure on a UL-SCH based on the RAR information. Msg3 may include an RRC connection request and a UE ID. The network may transmit Msg4 in response to Msg3. Msg4 may be handled as a contention resolution message on DL. As the UE receives Msg4, the UE may enter the RRC_CONNECTED state.

As described before, the UL grant included in the RAR schedules a PUSCH transmission to the BS. A PUSCH carrying an initial UL transmission based on the UL grant of the RAR is referred to as an Msg3 PUSCH. The content of the RAR UL grant start from the MSB and ends in the LSB, given as Table 4.

TABLE 4

| | Number of |
|---|---|
| RAR UL grant field | bits |
| Frequency hopping flag | 1 |
| Msg3 PUSCH frequency resource | 12 |
| allocation | |
| Msg3 PUSCH time resource allocation | 4 |
| Modulation and coding scheme (MCS) | 4 |
| Transmit power control (TPC) for | 3 |
| Msg3 PUSCH | |
| CSI request | |

A transmit power control (TPC) command is used to determine the transmission power of the Msg3 PUSCH. For example, the TPC command is interpreted according to Table 5.

TABLE 5

| TPC command | value [dB] |
|---|---|
| 0 | −6 |
| 1 | −4 |
| 2 | −2 |
| 3 | 0 |
| 4 | 2 |
| 5 | 4 |
| 6 | 6 |
| 7 | 8 |

### (2) 2-Step RACH: Type-2 Random Access Procedure

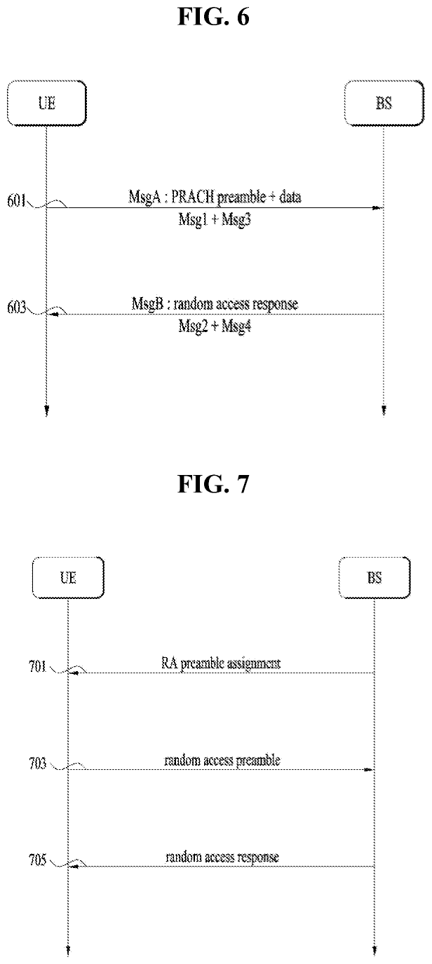

FIG. 6 is a diagram illustrating an exemplary 2-step RACH procedure.

A (contention-based) RACH procedure performed in two steps, that is, a 2-step RACH procedure has been proposed to simplify the RACH procedure and thus achieve low signaling overhead and low latency.

In the 2-step RACH procedure, the operation of transmitting Msg1 and the operation of transmitting Msg3 in the 4-step RACH procedure may be incorporated into an operation of transmitting one message, Message A (MsgA) including a PRACH and a PUSCH by the UE. The operation of transmitting Msg2 by the BS and the operation of transmitting Msg4 by the BS in the 4-step RACH procedure may be incorporated into an operation of transmitting one message, Message B (MsgB) including an RAR and contention resolution information.

That is, in the 2-step RACH procedure, the UE may combine Msg1 and Msg3 of the 4-step RACH procedure into one message (e.g., MsgA) and transmit the message to the BS (601).

Further, in the 2-step RACH procedure, the BS may combine Msg2 and Msg4 of the 4-step RACH procedure into one message (e.g., MsgB) and transmit the message to the UE (603).

The 2-step RACH procedure may become a low-latency RACH procedure based on the combinations of these messages.

More specifically, MsgA may carry the PRACH preamble included in Msg1 and the data included in Msg3 in the 2-step RACH procedure. In the 2-step RACH procedure, MsgB may carry the RAR included in Msg2 and the contention resolution information included in Msg4.

### (3) Contention-Free RACH

FIG. 7 is a diagram illustrating an exemplary contention-free RACH procedure.

The contention-free RACH procedure may be used for handover of the UE to another cell or BS or may be performed when requested by a BS command. The contention-free RACH procedure is basically similar to the contention-based RACH procedure. However, compared to the contention-based RACH procedure in which a preamble to be used is randomly selected from among a plurality of RACH preambles, a preamble to be used by the UE (referred to as a dedicated RACH preamble) is assigned to the UE by the BS in the contention-free RACH procedure (701). Information about the dedicated RACH preamble may be included in an RRC message (e.g., a handover command) or provided to the UE by a PDCCH order. When the RACH procedure starts, the UE transmits the dedicated RACH preamble to the BS (703). When the UE receives an RAR from the BS, the RACH procedure is completed (705).

In the contention-free RACH procedure, a CSI request field in an RAR UL grant indicates whether the UE is to include an aperiodic CSI report in a corresponding PUSCH transmission. An SCS for the Msg3 PUSCH transmission is provided by an RRC parameter. The UE may transmit the PRACH and the Msg3 PUSCH in the same UL carrier of the same serving cell. A UL BWP for the Msg3 PUSCH transmission is indicated by SystemInformationBlock1 (SIB1).

### (4) Mapping Between SSB Blocks and PRACH Resource (Occasion)

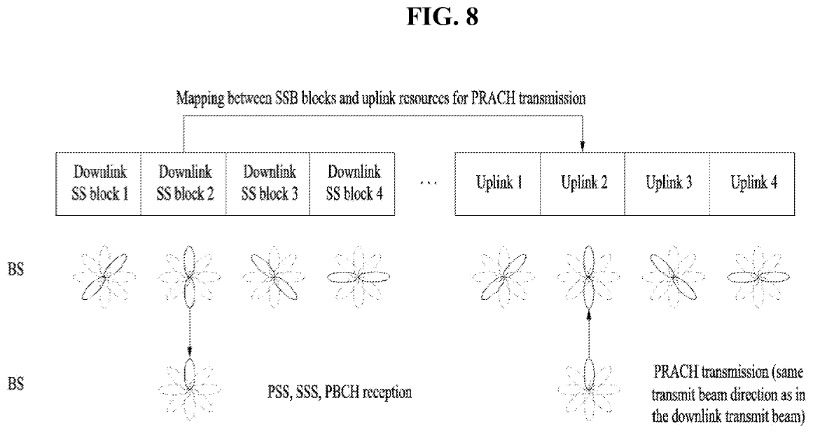

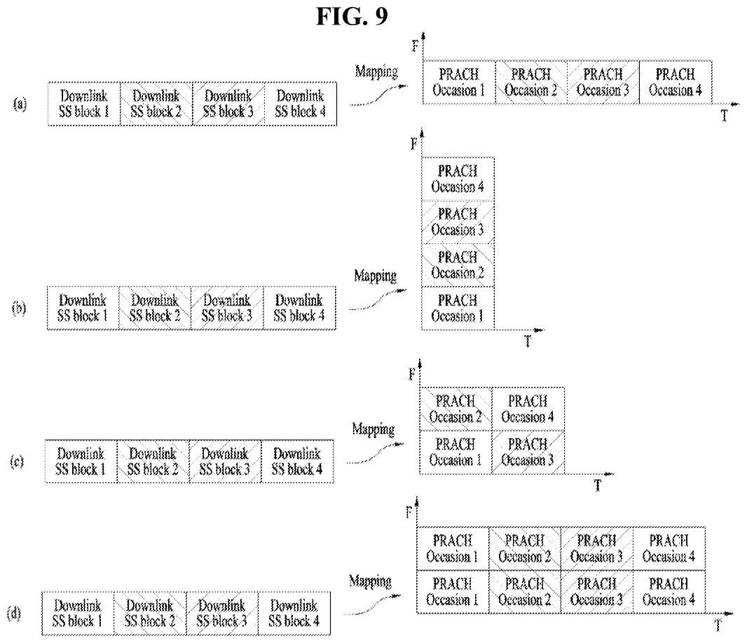

FIGS. 8 and 9 are diagrams illustrating transmission of SSBs and PRACH resources linked to the SSBs according to various embodiments of the present disclosure.

To communicate with one UE, the BS may need to find out what is the optimal beam direction between the BS and UE. Since it is expected that the optimal beam direction will vary according to the movement of the UE, the BS needs to continuously track the optimal beam direction. A process of finding out the optimal beam direction between the BS and UE is called a beam acquisition process, and a process of continuously tracking the optimal beam direction between the BS and UE is called a beam tracking process. The beam acquisition process may be required in the following cases: 1) initial access where the UE attempts to access the BS for the first time; 2) handover where the UE is handed over from one BS to another BS; and 3) beam recovery for recovering beam failure. The beam failure means a state in which while performing the beam tracking to find out the optimal beam between the UE and BS, the UE loses the optimal beam and thus is incapable of maintaining the optimal communication state with the BS or incapable of communicating with the BS.

In the NR system, a multi-stage beam acquisition process is being discussed for beam acquisition in an environment using multiple beams. In the multi-stage beam acquisition process, the BS and UE perform a connection setup by using a wide beam in the initial access stage. After the connection setup is completed, the BS and UE perform the highest quality of communication by using a narrow beam. The beam acquisition process in the NR system applicable to various embodiments of the present disclosure may be performed as follows.
1) The BS transmits a synchronization block for each wide beam to allow the UE to discover the BS in the initial access stage, that is, in order for the UE to find the optimal wide beam to be used in the first stage of the beam acquisition by performing cell search or cell acquisition and measuring the channel quality of each wide beam.
2) The UE performs the cell search on the synchronization block for each beam and acquires a DL beam based on the detection result for each beam.
3) The UE performs a RACH procedure to inform the BS that the UE discovers that the UE intends to access the BS.
4) The BS connects or associates the synchronization block transmitted for each beam with a PRACH resource to be used for PRACH transmission to allow the UE to simultaneously inform the RACH procedure and the DL beam acquisition result (e.g., beam index) at wide beam levels. If the UE performs the RACH procedure on a PRACH resource associated with the optimal beam direction that the UE finds, the BS obtains information regarding the DL beam suitable for the UE by receiving a PRACH preamble.

The present disclosure proposes the possibility of switching between channel access modes (LBT mode and no-LBT mode), conditions for switching, and methods of requesting such switching when it is configured or indicated in U-bands whether the no-LBT mode that allows transmission without CAPs including LBT is supported according to regional/national regulations. The present disclosure also proposes a method of establishing a reference point for short control signaling exemption (SCSe) that allows transmission without LBT when a duty cycle is met and a method of implicitly determining the applicability of SCSe based on configured resources. Further, the present disclosure proposes a method of performing subsequent transmission based on the length of a gap between transmissions within a COT obtained from LBT.

The U-band needs to follow the regulations defined for each region/country (e.g., ETSI EN 302 567). Depending on the region/country, the implementation of an appropriate channel access mechanism (e.g., LBT) may be essential for spectrum sharing among various systems operating in the same band.

However, according to specific regional/national regulations, the implementation of such a channel access mechanism may not be essential. In this case, a node may start transmission immediately as in an L-band, instead of performing the CAP such as LBT before the transmission as in a U-band. Such a channel access mode (e.g., LBT mode or no-LBT mode) may be configured/indicated by the BS. Even when operating in the no-LBT mode, the node may need to switch to the LBT mode for interference mitigation or other purposes.

In this case, depending on specific conditions configured to the UE, whether the UE is capable of autonomously changing the channel access mode may be configured/indicated together with the LBT mode. If the UE is not allowed to change the LBT mode according to the configuration/indication, the UE may request the BS to change the channel access mode.

Even when the UE is required to operate in the LBT mode, if the UE transmits signals and channels related to management and control within a duty cycle, the UE may skip LBT execution (the signals and channels may include, for example, ACK/NACK, time synchronization signals, and beam management-related signals). Here, the duty cycle may be defined as a part of a specific observation period (e.g., 100 ms), where the total transmission length of the duty cycle may be less than 10% (e.g., 10 ms) of the specific observation period. Whether LBT is performed may be determined depending on whether the conditions for the duty cycle are satisfied. Then, LBT may be applied to signal/channel transmission. This may be referred to as SCSe operation.

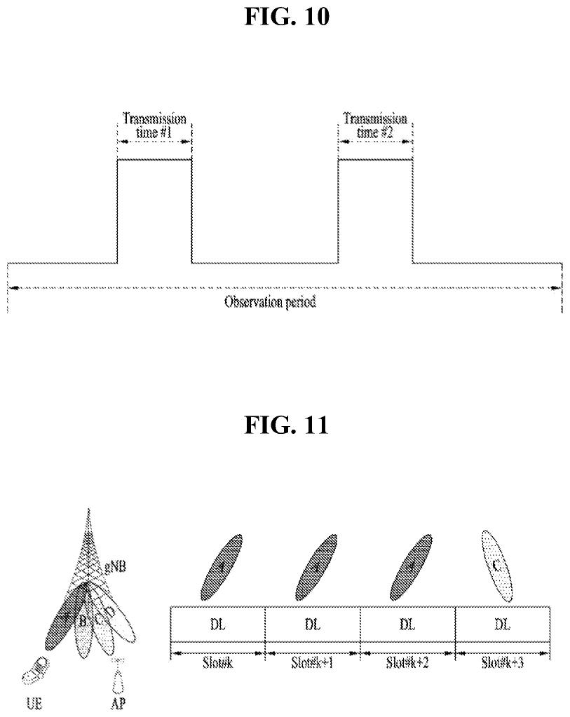

FIG. 10 illustrates a total observation period (e.g., 100 ms) and a duty cycle (e.g., a segment corresponding to 10% of the observation period, which equals 10 ms) in the corresponding observation period.

Hereinafter, the SCSe operation will be described with reference to FIG. 10. SCSe refers to the following transmission operation: when the total length of a period during which a specific DL/UL signal is transmitted is less than or equal to the length of a duty cycle within a total observation period (e.g., 100 ms) (for example, the duty cycle is a part corresponding to 10% of the observation period, which equals 10 ms), transmission may be allowed in the corresponding period without LBT even if the LBT is required by regulations and/or configurations. For example, referring to FIG. 10, when a period reserved for transmission of a specific DL/UL signal in an observation period is transmission time #1 and transmission time #2, if the total length of a period obtained by adding transmission time #1 and transmission time #2 is less than or equal to 10 ms, the duty cycle may be satisfied. Thus, the specific DL/UL signals may be transmitted without LBT in the period of transmission time #1 and transmission time #2. In contrast, if the total length of the period obtained by adding transmission time #1 and transmission time #2 exceeds 10 ms, the duty cycle may not be satisfied.

The SCSe operation may be permitted only for specific signals, and the specific signals may need to be allocated within a period satisfying the duty cycle based on the reference point of the observation period.

In high frequency bands above 52.6 GHZ, the following may be considered due to relatively larger path loss than low frequency bands: omnidirectional LBT (hereinafter O-LBT), where LBT is performed in all directions based on technologies such as analog beamforming using multiple antennas, and omnidirectional transmission/reception; and directional LBT (hereinafter D-LBT), where LBT is performed only in a specific beam direction, and directional transmission/reception. In a COT obtained when D-LBT or O-LBT based on random backoff-based LBT (e.g., Cat-3 LBT or Cat-4 LBT) is successful, transmission may continue without additional LBT depending on the gap between transmissions. Alternatively, short CCA such as Cat-2 LBT, which is non-backoff-based LBT, may be performed. If the CCA is successful, transmission may continue up to a MCOT. Otherwise, transmission may be allowed only within a limited period.

Before explaining the proposed methods, NR-based channel access schemes for U-bands applicable to the present disclosure may be classified as follows.
Category 1 (Cat-1): Next transmission is performed after a short switching gap immediately after the end of previous transmission within a COT. The switching gap is shorter than a specific length (e.g., 3 us and/or 16 us) and includes a transceiver turnaround time. Cat-1 LBT may correspond to the aforementioned Type 2C CAP.
Category 2 (Cat-2): Cat-2 refers to non-backoff LBT. Transmission may be performed immediately if the channel is determined to be idle for a specific period before the transmission. Cat-2 LBT may be further subdivided based on the length of a minimum sensing period required for channel sensing immediately before transmission. For example, Cat-2 LBT with a minimum sensing period of 25 us may correspond to the Type 2A CAP described above. Cat-2 LBT with a minimum sensing period length of 16 us can correspond to the Type 2B CAP described above. The length of the minimum sensing period is exemplary and may be shorter than 25 us or 16 us (e.g., 9 us).
Category 3 (Cat-3): Cat-3 refers to backoff-based LBT with a fixed contention window size (CWS). A transmitting entity selects a random number N within a (fixed) CWS ranging from 0 to the maximum. Whenever the transmitting entity confirms that the channel is idle, the transmitting entity decrements the counter value until the counter value reaches zero and performs transmission when the counter value becomes 0.
Category 4 (Cat-4): Cat-4 refers to backoff-based LBT with a variable CWS. A transmitting entity selects a random number N from in the range of 0 to a maximum CWS value (variable). Whenever the transmitting entity confirms that the channel is idle, the transmitting entity decrements the counter value until the counter value reaches zero and then performs transmission when the counter value becomes 0. If the transmitting entity receives feedback from a receiving entity that the transmission is not properly received, the transmitting entity increases the maximum CWS value to a higher level. The transmitting entity selects a random number again within the increased CWS value and performs the LBT procedure again. Cat-4 LBT may correspond to the Type 1 CAP described above.

In high frequency U-band above 52 GHZ, the BS or UE may perform, as the CAP, LBT in a specific beam direction or beam group LBT (D-LBT) in addition to O-LBT and then perform DL or UL signals/channels. For a COT obtained by performing LBT in a specific beam direction, transmission may be permitted after Cat-2 LBT (or Cat-1 LBT) depending on the gap between transmissions only for DL and UL that have a correlation (e.g., quasi co-located (QCL) relationship) with the beam direction in which LBT is performed, which is different from the COT obtained after O-LBT. For other signals/channels, it may be desirable to transmit DL/UL signals after random back-off based LBT (e.g., Cat-3 LBT or Cat-4 LBT).

When the BS or UE shares a COT, the BS or UE may perform Cat-2 LBT either in the forward direction within the COT or in the beam direction with a QCL relationship with the beam direction used to acquire the COT. When the UE receives DL signals/channels in a specific beam direction or beam group direction, the UE may be configured to monitor only a search space that has a QCL relationship within the corresponding COT.

For the following reasons, it may be desirable to have a spatial (partial) QCL relationship among all DL signals/channels (or UL signals/channels) included in one TX burst. For example, as shown in FIG. 11, after the BS succeeds in LBT, the BS may transmit a TX burst consisting of a total of four slots. After performing transmission in the direction of beam A in three slots, the BS may perform transmission in the direction of beam C in fourth slot.

However, while the BS transmits a signal in the direction of beam A. A Wi-Fi AP coexisting in the corresponding U-band may not detect signals transmitted in the direction of beam A. Thus, after determining that the Wi-Fi AP channel is idle, the Wi-Fi AP may start signal transmission and reception if LBT is successful. If the BS transmits a signal in the direction of beam C starting from slot #k+3, it may cause interference to a related Wi-Fi signal. As described above, if the BS using beam A changes the beam direction and transmits without additional LBT, it may cause interference to other coexisting wireless nodes. Thus, it may be desirable that the BS does not to change the transmission beam direction of the TX burst after LBT is successful.

A method of providing information regarding a beam to be used by the UE during UL transmission and reception by associating a DL signal and a UL signal is being considered in the NR system. For example, channel state information reference signal (CSI-RS) resources and sounding reference signal (SRS) resources may be linked. If there is a beam direction generated by the UE on the corresponding CSI-RS resources, the UE may transmit a UL signal based on a transmission beam corresponding to a beam for CSI-RS reception when transmitting an SRS on the SRS resources linked to the corresponding CSI-RS resources (or when transmitting a PUSCH scheduled by a UL grant in which the SRS resources linked to the corresponding CSI-RS resources are signaled). In this case, the relationship between a specific reception beam and a specific transmission beam may be configured by the UE implementation if the UE has beam correspondence capability. Alternatively, the relationship between a specific reception beam and a specific transmission beam may be established through training between the BS and UE if the UE does not have beam correspondence capability.

Therefore, when the association relationship between DL and UL signals is defined, COT sharing may be allowed between a DL TX burst composed of DL signals/channels in a spatial (partial) QCL relationship with a corresponding DL signal and a UL TX burst composed of UL signals/channels in a spatial (partial) QCL relationship with a UL signal associated with the corresponding DL signal.

The UL signals/channels may include at least one of the following signals/channels:
SRS, DMRS for PUCCH, DMRS for PUSCH, PUCCH, PUSCH and PRACH.

The DL signals/channels may include at least one of the following signals/channels:
PSS (primary synchronization signal), SSS (secondary SS), DMRS for PBCH, PBCH, TRS (tracking reference signal) or CSI-RS for tracking, CSI-RS for CSI (channel state information) acquisition and CSI-RS for RRM measurement, CSI-RS for beam management, DMRS for PDCCH, DMRS for PDSCH, PDCCH (or CORESET (control resource set) in which PDCCH transmission is allowed), and PDSCH. In addition, signals introduced for the purpose of tracking, fine time/frequency synchronization, coexistence, power saving, or achieving a frequency reuse factor of 1 and placed in the front of the TX burst may be included as the signals listed above, variations of the signals, or newly introduced signals.

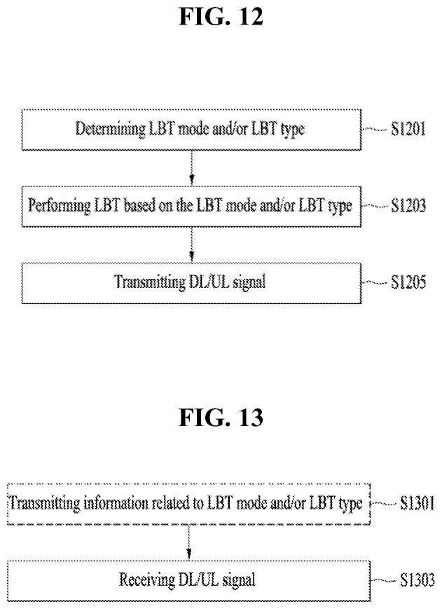

FIGS. 12 to 14 are diagrams for explaining overall operation processes of a UE and BS according to an embodiment of the present disclosure.

FIG. 12 is a diagram for explaining an overall operation process when the UE or BS is a transmitter according to the methods proposed in the present disclosure.

Referring to FIG. 12, the UE or BS may determine an LBT mode and/or LBT type (S1201). For example, a method by which the UE or BS determines the LBT mode and/or LBT type may be based on [Proposed Method #1] and/or [Proposed Method #4].

The UE or BS may perform LBT based on the LBT mode and/or LBT type (S1203). For example, if the LBT mode and/or LBT type is determined to be the no-LBT mode, LBT may not be performed. If the LBT mode and/or LBT type is determined to be the LBT mode, LBT may be performed to determine whether a related channel and/or beam direction is idle.

The UE or BS may transmit a UL/DL signal without LBT. Alternatively, after performing LBT, the UE or BS may transmit a UL/DL signal based on the determination that the related channel and/or beam direction is idle (S1205).

For example, S1203 and S1205 may be based on at least one of [Proposed Method #2] to [Proposed Method #4].

FIG. 13 is a diagram for explaining an overall operation process when the UE or BS is a receiver according to the methods proposed in the present disclosure.

Referring to FIG. 13, the BS may transmit information for indicating/configuring an LBT mode and/or LBT type to the UE (S1301). For example, the information transmitted by the BS may be based on [Proposed Method #1] and/or [Proposed Method #4].

In addition, when the BS performs DL transmission and when the UE autonomously determines the LBT mode and/or LBT type for UL transmission without instructions/configurations from the BS, S1301 may be omitted.

The UE or BS may receive a DL/UL signal transmitted according to the determined/instructed/configured LBT mode and/or LBT type (S1303). For example, the UE or BS may receive a DL/UL signal based on at least one of [Proposed Method #2] to [Proposed Method #4].

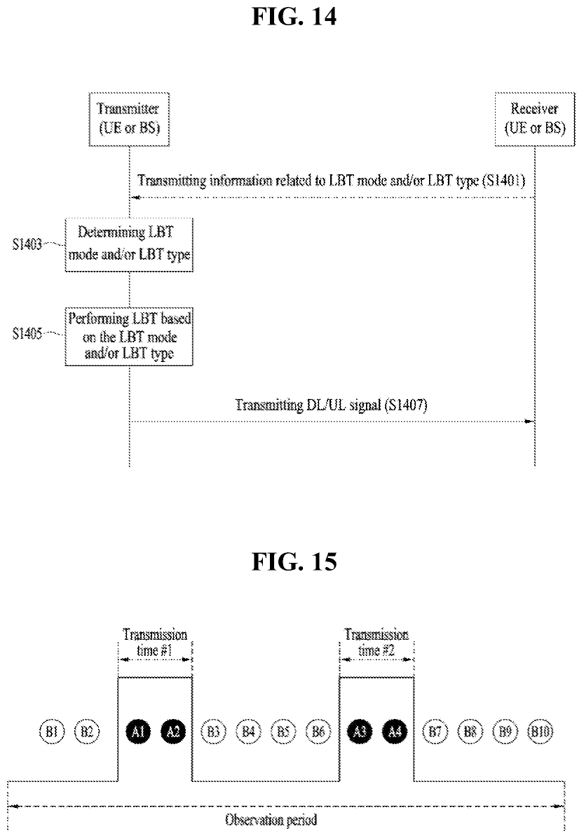

FIG. 14 is a diagram for explaining an overall operation process of a network according to the methods proposed in the present disclosure.

Referring to FIG. 14, the BS may transmit information for indicating/configuring a LBT mode and/or LBT type to the UE (S1401). For example, the information transmitted by the BS may be based on [Proposed Method #1] and/or [Proposed Method #4].

In addition, when the BS performs DL transmission and when the UE autonomously determines the LBT mode and/or LBT type for UL transmission without instructions/configurations from the BS, S1401 may be omitted.

The UE or BS may determine the LBT mode and/or LBT type (S1403). For example, a method by which the UE or BS determines the LBT mode and/or LBT type may be based on [Proposed Method #1] and/or [Proposed Method #4].

The UE or BS may perform LBT based on the LBT mode and/or LBT type (S1405). For example, if the LBT mode and/or LBT type is determined to be the no-LBT mode, LBT may not be performed. If the LBT mode and/or LBT type is determined to be the LBT mode, LBT may be performed to determine whether a related channel and/or beam direction is idle.

The UE or BS may transmit a UL/DL signal without LBT. Alternatively, after performing LBT, the UE or BS may transmit a UL/DL signal based on the determination that the related channel and/or beam direction is idle (S1407).

For example, S1405 and S1407 may be based on at least one of [Proposed Method #2] to [Proposed Method #4].

[Proposed Method #1] when the BS Configures/Indicates to the UE an Operation Mode, the BS Configures the Possibility of Switching of an LBT Operation Mode (e.g., LBT Mode or No-LBT Mode) and Switching Conditions Together According to at Least One of the Following: [Embodiment #1-1] to [Embodiment #1-6].

### 1. Embodiment #1-1

The UE may be configured/instructed to switch to the LBT operation mode only based on instructions/configurations of the BS.

However, the BS may configure UL resources (e.g., configured granted physical uplink shared channel (CG-PUSCH)) to the UE in advance. The BS may receive reports on interference conditions around UEs (e.g., received signal strength indicator (RSSI) measurement, Cat-2 LBT, etc.) periodically or aperiodically. The BS may check whether switching of the LBT operation mode is necessary and configure/instruct the UE to switch the LBT operation mode.

### 2. Embodiment #1-2

The UE may be configured/instructed to switch to the LBT operation mode only based on instructions/configurations of the BS. When at least one of the following: [LBT operation mode switching conditions] described below are satisfied, the UE may be configured/instructed to send a request to switch the LBT operation mode to the BS. For example, if at least one of [LBT operation mode switching condition #1] is satisfied, the UE may send a request to switch from the no-LBT mode to the LBT mode to the BS.

However, the request to switch the LBT operation mode may be transmitted to the BS on preconfigured UL resources (e.g., sounding reference signal (SRS), CG-PUSCH, random access channel (RACH), and physical uplink control channel (PUCCH)).

### 3. Embodiment #1-3

If [LBT operation mode switching conditions] described below are satisfied, the UE may be configured/instructed to autonomously switch the LBT operation mode without instructions/configurations of the BS. For example, if at least one of [LBT operation mode switching condition #1] is satisfied, the UE may autonomously switch from the no-LBT mode to the LBT mode.

However, after switching the LBT operation mode, the UE may inform the BS the following fact based on preconfigured UL resources (e.g., SRS, CG-PUSCH, RACH, PUCCH, etc.): the LBT operation mode is switched.

However, the UE and BS may operate in different LBT operation modes. Additionally, for purposes such as COT sharing, the UE or BS may inform the BS or UE of the LBT operation mode of the UE or BS periodically or over preconfigured channels/signals/resources according to configurations/instructions.

### [LBT Operation Mode Switching Condition #1]

(1) When the surrounding interference level is measured based on RSSI measurement, the following condition may be considered: (i) RSSI measurement value>threshold, (ii) (number of occurrences of interference level lower than threshold)/(number of times of RSSI measurement)>threshold, and/or (iii) one-shot RSSI value (e.g., Cat-2 LBT) is higher than threshold N times or more.

The thresholds of (i), (ii), and (iii) may be the same or different. The thresholds of (i), (ii), and (iii) may be configured/indicated in advance by the BS together with the value of N or predefined (for example, in specifications).

(2) When HARQ-ACK feedback results for signals/channels transmitted in the no-LBT mode are (i) a NACK N times (or consecutively N times) or (ii) have a ratio of (number of NACK CBGs/TBs)/(total number of CBGs/TBs) is equal to or greater than X %.

For example, for a PUSCH, whether condition (2) is satisfied may be determined based on feedback such as an A/N in the case of a new data indicator (NDI) value in a UL grant, code block group transmission information (CBGTI), or configured grant downlink feedback information (CG-DFI).

However, the values of N and X may be configured/indicated in advance by the BS or predefined (for example, in specifications). The referenced HARQ-ACK feedback may be limited to transmission included in a specific reference duration.

### 4. Embodiment #1-4

The UE may inform the BS of the current LBT operation mode (e.g., LBT mode or no-LBT mode) of the UE through a specific field of configured granted uplink control information (CG-UCI) or a specific state (e.g., state defined in specifications or configured/indicated in advance by the BS) of an existing field whenever transmitting a CG-PUSCH periodically or aperiodically.

### 5. Embodiment #1-5

To indicate the possibility of COT sharing, the BS may provide UEs with information regarding the LBT operation mode used for DL transmission by the BS over a UL grant or group common physical downlink control channel (GC-PDCCH) depending on the LBT operation mode of the BS.

### 6. Embodiment #1-6

The BS may instruct UEs located in a specific area (e.g., a specific tracking area) or UL beams corresponding to a specific DL beam to switch the LBT operation mode over a GC-PDCCH. Alternatively, the BS may inform the UEs that the LBT operation mode switching is allowed.

In areas where the implementation of a channel access mechanism such as LBT is not required for channel access, the BS may configure for the UE whether the UE operates in the LBT mode or no-LBT mode cell-specifically using system information such as a system information block (SIB) or UE-specifically using dedicated RRC signaling. The BS may use both of the two methods described above. The BS and UE may perform transmission while operating in different LBT operation modes. This is because in high frequency bands, when transmission in a specific beam direction is performed, the level of interference may vary depending on the beam direction or the location of each UE/BS.

However, when the density of UEs is very high or when decoding failure continuously occurs due to collision with other transmissions, it may be inefficient for the BS/UE operating in the no-LBT mode to continuously operate in the no-LBT mode. Thus, the BS/UE may need to switch the LBT operating mode to the LBT mode.

For example, if the UE operating in the no-LBT mode is configured/instructed to switch the LBT operation mode and perform the CAP using the LBT mode in high interference situations, the probability of transmission collision may be reduced. Furthermore, when the interference level decreases again, the UE may efficiently perform transmission by quickly accessing the channel using the no-LBT mode and immediately starting the transmission. In other words, in low interference situations, efficient transmission may be achieved by starting transmission without LBT.

The UE may autonomously perform the above-described LBT operation mode switching if specific conditions are met, or the UE may switch to the LBT mode only according to instructions/configurations of the BS. When the BS configures to the UE the LBT operation mode such as the LBT mode or no-LBT mode, the BS may also configure whether the LBT operation mode switching is allowed.

The UE may be configured/instructed to always operate in the LBT operation mode configured/indicated by the BS, regardless of interference situations or decoding failure of UL transmission. If the BS does not change the LBT operation mode of the UE cell-specifically or UE-specifically, the UE may operate by maintaining the configured LBT operation mode. The BS may configure UL resources (e.g., SRS, CG-PUSCH, RACH and/or PUCCH) in advance. In this case, the BS may receive reports of interference situations around UEs (e.g., RSSI measurement, Cat-2 LBT, etc.) periodically or aperiodically. Then, the BS may check whether the LBT operation mode switching is necessary and configure/instruct the UE to perform the LBT operation mode switching.

As described above, the LBT operation mode switching may be necessary for reasons such as interference situations or transmission collision/failure. The UE may not autonomously switch the LBT operation mode based on its own determination. In other words, the UE may switch the LBT operation mode only according to configurations/instructions of the BS. However, even in this scenario, if at least one of [LBT operation conversion conditions] is satisfied, the UE may be configured/instructed to send a request to switch the LBT operation mode to the BS. For example, the request to switch the LBT operation mode of the UE may be transmitted to the BS on preconfigured UL resources (e.g., SRS, CG-PUSCH, RACH, PUCCH, etc.).

When the above-mentioned LBT operation mode switching conditions are satisfied, the UE may be configured/instructed to autonomously switch the LBT operation mode without instructions/configuration of the BS. When the UE switches the LBT operation mode only based on instructions/configurations of the BS, or when the UE sends a request to switch the LBT operation mode to the BS if the LBT operation mode switching conditions are met, the UE needs to exchange information such as additional signaling for the LBT operation mode switching with the BS. It may be difficult for the UE to switch the LBT operation mode relatively quickly when the LBT operation mode switching is required.

Therefore, when the UE is allowed to autonomously switch the LBT operation mode if the LBT operation mode switching conditions are met, the UE may switch the LBT operation mode quickly, thereby reducing additional transmission collision or transmission failure. Considering that the UE and BS may operate in different LBT operation modes, for COT sharing with BS or LBT failure indication, the UE may inform the BS that the UE switches the LBT operation mode, using preconfigured UL resources (e.g., SRS, CG-PUSCH, RACH, PUCCH, etc.) after switching the LBT operation mode.

The conditions for switching from the no-LBT mode to the LBT mode has been described in [LBT operation mode switching condition #1]. However, if [LBT operation mode switching condition #2] is satisfied while the UE operates after switching to the LBT mode, the UE may send a request to from the LBT mode to the no-LBT mode according to configurations/instructions as in the embodiments of [Proposed Method #1] (particularly, Embodiment #1-2 and/or Embodiment #1-3) or autonomously switch the LBT operation mode from the LBT mode to the no-LBT mode

### [LBT Operation Mode Switching Condition #2]

(1) When the surrounding interference level is measured based on RSSI measurement, the following condition may be considered: (i) RSSI measurement value<threshold, (ii) (number of occurrences of interference level lower than threshold)/(number of times of RSSI measurement)<threshold, and/or (iii) one-shot RSSI value (e.g., Cat-2 LBT) is lower than threshold N times or more.

The thresholds of (i), (ii), and (iii) may be the same or different. The thresholds of (i), (ii), and (iii) may be configured/indicated in advance by the BS together with the value of N or predefined (for example, in specifications).

(2) When HARQ-ACK feedback results for signals/channels transmitted in the LBT mode are (i) an ACK N times (or consecutively N times) or (ii) have a ratio of (number of ACK CBGs/TBs)/(total number of CBGs/TBs) is equal to or greater than X %. (3) When random backoff-based LBT for transmission (e.g., Cat-3 LBT or Cat-4 LBT) succeeds N times (or consecutively N times) (within a specific window period).

For example, for a PUSCH, whether condition (2) is satisfied may be determined based on feedback such as an A/N in the case of a NDI value in a UL grant, CBGTI, or CG-DFI.

However, the values of N and X and the window period may be configured/indicated in advance by the BS or predefined (for example, in specifications). The referenced HARQ-ACK feedback may be limited to transmission included in a specific reference duration.

In the above-described embodiment, if the UE is incapable of autonomously switching the LBT operation mode (i.e., if the LBT operation mode of the UE is switched only by the BS), the BS may know whether the LBT operation mode of the UE is either the LBT mode or no-LBT mode because the BS directly configure/indicates the LBT operation mode. However, if the UE is capable of autonomously switching the LBT operation mode by determining whether the LBT operation switching conditions are satisfied, the BS may not know the LBT operation mode used by the UE for current UL transmission.

The UE may inform the BS of the current LBT operation mode (e.g., LBT mode or no-LBT mode) of the UE through a specific field of CG-UCI or a specific state (e.g., state defined in specifications or configured/indicated in advance by the BS) of an existing field whenever transmitting a CG-PUSCH periodically or aperiodically. The UE may inform the BS of the LBT operation mode of the UE. The BS may use information regarding the corresponding LBT operation mode to share the COT of the UE for the CG-PUSCH transmitted in the LBT mode and perform DL transmission within the shared COT.

On the other hand, in the no-LBT mode, the COT, which refers to a period where transmission is capable of being performed without additional LBT, may not be defined, and thus COT sharing may not be defined. Therefore, COT sharing may or may not be possible depending on the LBT operation mode based on DL transmission of the BS.

To indicate the possibility of COT sharing, the BS may provide UEs with information regarding the LBT operation mode used for DL transmission by the BS over a UL grant or GC-PDCCH depending on the LBT operation mode of the BS.

If there is no field in the GC-PDCCH that provides COT information and information regarding a frequency region in which the BS succeeds in LBT or if the value of the corresponding field is determined/configured/indicated in advance, the UE may consider that the BS performs DL transmission in the no-LBT mode.

Additionally, considering that the appropriate LBT operation mode may vary instantaneously depending on the interference situations, the BS may instruct UEs located in a specific area (e.g., a specific tracking area) or UL beams corresponding to a specific DL beam to switch the LBT operation mode over a GC-PDCCH. Alternatively, the BS may inform the UEs that the LBT operation mode switching is allowed.

[Proposed Method #2] when the UE Performs LBT in the LBT Mode and when the UE is Configured with a RACH Configuration, the UE May Implicitly Check Whether SCSe is Applicable if the UE is Configured with the Reference Point of an Observation Period for Checking a Duty Cycle and then Transmit Msg1 or MsgA According to at Least One of [Embodiment #2-1] to [Embodiment #2-3].

### 1. Embodiment #2-1

When the UE performs a 4-step RACH procedure and is configured with the reference point of the observation period,

(1) The UE may transmit Msg1 without LBT on RACH occasions (ROs) that satisfy the duty cycle among ROs included within the observation period from the reference point. In addition, the UE may transmit Msg1 by performing LBT on other ROs (i.e., ROs that do not satisfy the duty cycle).

(2) If all ROs included within the observation period from the reference point satisfy the duty cycle, the UE may transmit Msg1 without LBT on all Ros. Otherwise (i.e., if at least one RO does not satisfy the duty cycle), the UE may transmit Msg1 by performing LBT on all ROs.

### 2. Embodiment #2-2

When the UE performs the 2-step RACH procedure and is configured with the reference point of the observation period,

(1) The UE may transmit both MsgA and a MsgA PUSCH without LBT on ROs and PUSCH occasions (POs) that satisfy the duty cycle among all ROs and POs included within the observation period from the reference point. The UE may transmit MsgA and the MsgA PUSCH by performing LBT on the remaining ROs and POs out of the duty cycle (i.e., ROs and POs that do not satisfy the duty cycle).

(2) When All ROs and POs included within the observation period from the reference point satisfy the duty cycle, the UE may transmit both MsgA and the MsgA PUSCH without LBT on all ROs and POs. Otherwise (if at least one of all ROs and POs does not satisfy the duty cycle), the UE may transmit MsgA and the MsgA PUSCH by applying LBT on all ROs and POs.

### 3. Embodiment #2-3

When the UE performs the 2-step RACH procedure and is configured with the reference point of the observation period,

(1) If only ROs (or POs) satisfy the duty cycle, the UE may transmit MsgA (or MsgA PUSCH) without LBT only on the ROs (or POs). In this case, the UE may drop the MsgA PUSCH (or MsgA) on POs (or ROs) that do not satisfy the duty cycle. Alternatively, the UE may transmit the MsgA PUSCH (or MsgA) by performing LBT on the POs (or ROs) that do not satisfy the duty cycle.

However, the reference point of the observation period for checking the duty cycle may not always be configured. When the reference point is configured, the reference point may be configured/indicated based on a specific system frame number (SFN) or slot. If there is no value configured/indicated for the reference point, it may be assumed by default that the observation period window repeats periodically and infinitely on the time axis based on SFN=0.

Alternatively, the UE may consider, as the observation period, a duration of 100 ms before the last RO/PO associated with a Msg1/MsgA resource (e.g., SS/PBCH block (synchronization signal/physical broadcast channel block)) selected by the UE or a duration of 100 ms after the start of the Msg1/MsgA resource. The UE may check whether the duty cycle is satisfied and apply at least one of [Embodiment #1-1] to [Embodiment #1-3] described above. The observation period and duty cycle may be defined according to the regulations of each region/country or may be configured/indicated to the UE by the BS. For example, in an observation period of 100 ms, the total duration of short control signaling (SCS) transmission may be configured to not exceed 10 ms.

When the UE performs LBT in the LBT mode, if the transmission length of control information or management information (e.g., ACK/NACK, synchronization signal, beam management signal, etc.) satisfies the duty cycle conditions within a specific observation period, the control information or management information may be transmitted without LBT.

Msg1 in the 4-step RACH and MsgA in the 2-step RACH are essential signals/channels for initial access or synchronization of the UE. Therefore, if the UE performs LBT to transmit Msg1 and MsgA, there may be transmission delays due to the possibility of LBT failure and the time required to perform LBT. This may result in initial access delays, causing the UE to remain in a non-communicative state for an extended period or prevent the UE from performing normal communication.

Therefore, the reference point of the observation period for checking the duty cycle check may be configured together with RACH configurations. Thus, the UE checks whether SCSe is applicable to Msg1 and/or MsgA. The UE is capable of transmitting Msg1 and/or MsgA without LBT if the duty cycle is satisfied. Accordingly, the UE may perform the RACH procedure quickly with no errors.

When the UE performs the 4-step RACH procedure and is configured with the reference point of the observation period as in [Embodiment #2-1], (1) the UE may transmit Msg1 on ROs that satisfy the duty cycle among ROs included in the observation period from the reference point without LBT. On the other hand, the UE may transmit Msg1 on other ROs (i.e., ROs that do not satisfy the duty cycle) by performing LBT. For example, referring to FIG. 15, it is assumed that A1 to A4 and B1 to B10 are ROs, and the length of a duration obtained by adding transmission time #1 and transmission time #2 where A1 to A4 are allocated satisfy the duty cycle. If the UE transmits Msg1 only on A1 to A4, the duty cycle may be satisfied, and thus, the UE may transmit Msg1 without LBT. On the other hand, if the UE transmits Msg1 on A1 to A4 and also transmits Msg1 on at least one RO of B1 to B10, the UE may transmit Msg1 on A1 to A4 without LBT and transmit Msg1 on at least one RO of B1 to B10 after performing LBT.

As another example, referring to FIG. 15, when a plurality of UEs (e.g., UE #1 to UE #14) located in at least one cell transmit Msg1 on ROs of A1 to A4 and B1 to B10, if UE #1 to UE #4 intends to transmit Msg1 on each RO of A1 to A4, UE #1 to UE #4 may transmit Msg1 without LBT. If UE #5 to UE #14 intends to transmit Msg1 on each RO of B1 to B10, UE #5 to UE #14 may transmit Msg1 after performing LBT.

Alternatively, (2) if all ROs included in the observation period from the reference point satisfy the duty cycle, the UE may transmit Msg1 on all ROs without LBT. Otherwise (i.e., when at least one RO does not satisfy the duty cycle), the UE may transmit Msg1 on all ROs by performing LBT.

For example, referring to FIG. 15, it is assumed that A1 to A4 and B1 to B10 are ROs, and the length of a duration obtained by adding transmission time #1 and transmission time #2 where A1 to A4 are allocated satisfy the duty cycle. If the UE transmits Msg1 only within A1 to A4, the duty cycle may be satisfied, and thus, the UE may transmit Msg1 without LBT. On the other hand, if the UE transmits Msg1 on A1 to A4 and at least one of B1 to B10, the UE may transmit Msg 1 after performing LBT not only on at least one RO of B1 to B10 but also on A1 to A4 because the sum of the transmission durations of at least one RO of A1 to A4 and B1 to B10 may exceed a length (e.g., 10 ms) corresponding to a certain percentage (e.g., 10%) of the total length of the observation period.

As another example, referring to FIG. 15, when a plurality of UEs (e.g., UE #1 to UE #14) located in at least one cell transmit Msg1 on ROs of A1 to A4 and B1 to B10, if UE #1 to UE #4 intends to transmit Msg1 on each RO of A1 to A4, and if UE #5 to UE #14 intends to transmit Msg1 on each RO of B1 to B10, all of UE #1 to UE #14 may transmit Msg1 after performing LBT, regardless of the transmission order or occupancy order.

When the UE performs the 2-step RACH procedure and is configured with the reference point of the observation period as in [Embodiment #2-2], (1) the UE may transmit both MsgA and a MsgA PUSCH without LBT on ROs and POs that satisfy the duty cycle among all ROs and POs included within the observation period from the reference point. The UE may transmit MsgA and the MsgA PUSCH by performing LBT on the remaining ROs and POs out of the duty cycle (i.e., ROs and POs that do not satisfy the duty cycle).

For example, referring to FIG. 15, it is assumed that A1, A3, B1, B3, B5, B7, B9 are ROs, A2, A4, B2, B4, B6, B8, and B10 are POs, and the length of a duration obtained by adding transmission time #1 and transmission time #2 where A1 to A4 are allocated satisfy the duty cycle. If the UE transmits MsgA and/or a MsgA PUSCH only on A1 to A4, the duty cycle may be satisfied, and thus the UE may transmit MsgA and/or the MsgA PUSCH without LBT. On the other hand, if the UE intends to transmit MsgA and/or the MsgA PUSCH on A1 to A4, and if the UE intends to transmit MsgA and/or the MsgA PUSCH on at least one RO and/or PO of B1 to B10, the UE may transmit Msg1 and/or the MsgA PUSCH on A1 to A4 without LBT, and the UE may transmit MsgA and/or the MsgA PUSCH on at least one RO and/or PO of B1 to B10 after performing LBT.

As another example, referring to FIG. 15, when a plurality of UEs (e.g., UE #1 to UE #7) located in at least one cell transmit MsgA and/or a MsgA PUSCH on ROs and/or POs of A1 to A4 and B1 to B10, if UE #1 and UE #2 intends to transmit MsgA and/or the MsgA PUSCH on each RO of A1 to A4, UE #1 and UE #2 may transmit MsgA and/or the MsgA PUSCH without LBT. If UE #3 to UE #7 intends to transmit MsgA and/or the MsgA PUSCH on each RO and/or PO of B1 to B10, UE #3 to UE #7 may transmit MsgA and/or the MsgA PUSCH after performing LBT.

Alternatively, (2) when all ROs and POs included within the observation period from the reference point satisfy the duty cycle, the UE may transmit both MsgA and a MsgA PUSCH without LBT on all ROs and POs. Otherwise (if at least one of all ROs and POs does not satisfy the duty cycle), the UE may transmit MsgA and the MsgA PUSCH by applying LBT on all ROs and POs.

For example, referring to FIG. 15, it is assumed that A1, A3, B1, B3, B5, B7, B9 are ROs, A2, A4, B2, B4, B6, B8, and B10 are POs, and the length of a duration obtained by adding transmission time #1 and transmission time #2 where A1 to A4 are allocated satisfy the duty cycle. If the UE transmits MsgA and/or a MsgA PUSCH only on A1 to A4, the duty cycle may be satisfied, and thus the UE may transmit MsgA and/or the MsgA PUSCH without LBT. On the other hand, if the UE intends to transmit MsgA and/or the MsgA PUSCH on A1 to A4, and if the UE intends to transmit MsgA and/or the MsgA PUSCH on at least one RO and/or PO of B1 to B10, the UE may transmit MsgA and/or the MsgA PUSCH after performing LBT not only on at least one RO and/or PO of B1 to B10 but also on A1 to A4.

As another example, referring to FIG. 15, when a plurality of UEs (e.g., UE #1 to UE #7) located in at least one cell transmit MsgA and/or a MsgA PUSCH on ROs and/or POs of A1 to A4 and B1 to B10, if UE #1 and UE #2 intends to transmit MsgA and/or the MsgA PUSCH on each RO of A1 to A4, and if UE #3 to UE #7 intends to transmit MsgA and/or the MsgA PUSCH on each RO and/or PO of B1 to B10, all of UE #1 to UE #7 may transmit MsgA and/or the MsgA PUSCH after performing LBT,

When the UE performs the 2-step RACH procedure and is configured with the reference point of the observation period as in [Embodiment #2-3], if among configured ROs and POs, only the ROs satisfy the duty cycle, the UE may transmit MsgA without LBT only on the ROs. In this case, the UE may drop a MsgA PUSCH on the POs. Alternatively, the UE may transmit the MsgA PUSCH by performing LBT on the POs. Similarly, if only the POs among the configured ROs and POs satisfy the duty cycle, the UE may transmit the MsgA PUSCH without LBT only on the POs. In this case, the UE may drop MsgA on the ROs. Alternatively, the UE may transmit MsgA by performing LBT on the ROs.

For example, referring to FIG. 15, it is assumed that A1 to A4 are ROs, B to B10 are POs, and the length of a duration obtained by adding transmission time #1 and transmission time #2 where A1 to A4 are allocated satisfy the duty cycle. If the UE transmits MsgA on A1 to A4 and transmits a MsgA PUSCH on B3, B4, B7 and B8, the UE may transmit MsgA without LBT on A1 to A4, and the UE may drop the MsgA PUSCH on B3, B4, B7, and B8 or transmit the MsgA PUSCH after performing LBT on B3, B4, B7, and B8.

On the contrary, it is assumed that A1 to A4 are POs, B1 to B10 are ROs, and the length of a duration obtained by adding transmission time #1 and transmission time #2 where A1 to A4 are allocated satisfy the duty cycle. If the UE transmits a MsgA PUSCH on A1 to A4 and transmits MsgA B1, B2, B5, and B6, the UE may drop MsgA on B1, B2, B5, and B6 or transmit MsgA after performing LBT on B1, B2, B5, and B6, and the UE may transmit the MsgA PUSCH without LBT on A1 to A4.

As another example, referring to FIG. 15, it is assumed that A1 to A4 are ROs and B1 to B10 are POs. When a plurality of UEs (e.g., UE #1 to UE #4) located in at least one cell intends to transmit MsgA on A1 to A4 and transmit a MsgA PUSCH on B3, B4, B7, and B8, UE #1 to UE #4 may transmit MsgA without LBT, and UE #1 to UE #4 may transmit the MsgA PUSCH after performing LBT or drop the MsgA PUSCH.

On the contrary, it is assumed that A1 to A4 are POs and B1 to B10 are ROs. When a plurality of UEs (e.g., UE #1 to UE #4) located in at least one cell intends to transmit MsgA on B1, B2, B5, and B6 and transmit a MsgA PUSCH on A1 to A4, the plurality of UEs may transmit the MsgA PUSCH without LBT, and the plurality of UEs may transmit MsgA after performing LBT or drop MsgA.

[Proposed Method #3] when the BS/UE Performs LBT in the LBT Mode, the BS/UE May Limit the Length of Subsequent UL/DL Transmission Depending on the Length of a Gap Between Transmissions (i.e., Gap Required for DL-to-UL Switching or UL-to-DL Switching) and the Presence of Additional LBT in COT Sharing where a COT Obtained from an LBT Process (e.g., Cat-3 LBT or Cat-4 LBT) is Provided to the UE/BS to Continue UL/DL Transmission.

### 1. Embodiment #3-1

If the gap between transmissions is within 3 us, the BS or UE may continue subsequent DL/UL transmission without additional LBT by sharing a COT within a MCOT. For example, in DL/UL switching situations such as DL-to-UL switching or UL-to-DL switching, if the BS or UE is capable of starting transmission within 3 us, the BS or UE may continue subsequent DL/UL transmission without additional LBT by sharing a COT within the MCOT.

### 2. Embodiment #3-2

When the gap between transmissions is more than or equal to 3 us, or when the gap between transmissions is more than 3 us and less than X us,
(1) If the BS or UE does not perform additional LBT (i.e., Cat-1 LBT), the length of subsequent transmission may be limited to Y ms or less.
(2) If the BS or UE successfully performs additional Cat-2 LBT, the BS or UE may continue subsequent DL/UL transmission by sharing a COT within the MCOT. In this case, the BS or UE may perform DL/UL switching and DL/UL transmission multiple times within the MCOT.
(3) The BS or UE may acquire a new COT again through LBT (for example, Cat-3 LBT or Cat-4 LBT) without sharing a previously acquired COT. The BS or UE may start DL/UL transmission based on the new COT.
(4) If the BS or UE performs and succeeds in Cat-2 LBT, the BS or UE may continue subsequent DL/UL transmission by sharing a COT within the MCOT. In this case, DL/UL switching may be allowed only once at most.

However, the values of X and/or Y may be configured/indicated in advance by the BS or be predefined in specifications. In [Embodiment #3-1] and/or [Embodiment #3-2], LBT (e.g., Cat-3 LBT or Cat-4 LBT) may be one of O-LBT, LBT in a specific beam direction, and beam group LBT. In this case, COT sharing may be allowed only for LBT in the specific direction, and COT sharing may not be allowed for O-LBT or beam group LBT. In the case of a COT obtained from LBT in the specific beam direction, COT sharing may be allowed only for DL/UL transmission having a QCL relationship with a beam direction in which LBT is performed. For DL/UL transmission with no QCL relationship with a beam direction in which LBT is performed, a COT may need to be obtained by performing LBT (e.g., Cat-3 LBT or Cat-4 LBT) to perform the DL/UL transmission in the corresponding beam direction with no QCL relationship,

In Rel-16 NR-U, there are a total of four CAPs: Type 1 CAP, Type 2A CAP, Type 2B CAP, and Type 2C CAP. The Type 2A/2B/2C CAPs may be applied within a COT obtained by the BS or UE through the Type 1 CAP (however, when only a discovery burst with a maximum transmission length of 1 ms is transmitted with no PDSCH, or when the discovery burst and non-unicast information are multiplexed, the Type 2A CAP may be applied instead of the Type 1 CAP).

Among the Type 2A/2B/2C CAPs, a CAP to be used is determined based on the gap between DL-to-UL transmissions or UL-to-DL transmissions within the COT. The Type 2A/2B CAPs may be classified as Cat-2 LBT, and the Type 2C CAP may be classified as Cat-1 LBT. Additionally, the Type 1 CAP may be classified into Cat-3 LBT or Cat-4 LBT.

For example, the Type 2A CAP is applicable when the gap between DL-to-UL transmissions within the COT is 25 us. If the Type 2A CAP is successful at the 25 us gap, multiple UL/DL transmissions may be transmitted based on switching. If the gap between transmissions is greater than 25 us, DL-to-UL switching is allowed once. If Cat-2 LBT is successful within the corresponding COT, the remaining COT after DL transmission may be shared with the UE within a range that does not exceed the MCOT, allowing UL transmission to be performed.

If the gap between transmissions is exactly 16 us and if transmission is capable of being started immediately without LBT, the Type 2C CAP may be applied, and the transmission length is limited to a maximum of 584 us.

Meanwhile, even in high-frequency U-bands above 52.6 GHZ, when the BS or UE operates in the LBT mode, if LBT is successful through Cat-3 LBT or Cat-4 LBT, the BS or UE may obtain a COT (e.g., MCOT=5 ms). The BS or UE may share the COT by applying an appropriate type of LBT depending on the gap between transmissions within the COT. In other words, the method of limiting the length of subsequent transmission depending on the length of the gap between transmissions (e.g., the length of the gap required for DL-to-UL switching or UL-to-DL switching) and the presence of additional LBT may be equally applied.

For example, when the gap between transmissions is within 3 μs as in [Embodiment #3-1], the BS or UE may continue subsequent DL/UL transmission without additional LBT by sharing a COT within the MCOT. For example, in DL/UL switching situations such as DL-to-UL switching or UL-to-DL switching, if the BS or UE is capable of starting transmission immediately within 3 us, The BS or UE may continue subsequent DL/UL transmission without additional LBT by sharing the COT within the MCOT.

In this case, 3 us in bands above 52.6 GHz may be considered equivalent to 16 μs in a band of 5 GHz and correspond to the length of a short inter-frame space (SIFS) in WiGig. In WiGig, when there is a gap larger than 3 us, it is difficult to guarantee collision-free transmission because other nodes start transmission. Thus, LBT needs to be performed again to obtain a COT. Similarly, in NR systems operating above 52.6 GHz, if the gap between transmissions is within 3 us and transmission is capable of being resumed immediately, subsequent DL/UL transmission may continue within a range that does not exceed the MCOT without additional LBT.

When the gap between transmissions is more than 3 us or when the gap between transmissions is more than 3 us and less than X us, the transmission length of subsequent DL/UL transmission may or may not be limited depending on the presence of additional LBT.

If the BS or UE does not perform additional LBT (i.e., Cat-1 LBT), a method of limiting the length of subsequent DL/UL transmission to Y ms or less may be applied similarly to applying the Type 2C CAP at a gap of 16 us in NR-U,

On the other hand, if the BS or UE performs and succeeds in additional Cat-2 LBT, the BS or UE may continue subsequent DL/UL transmission by sharing a COT within the MCOT. In this case, the BS or UE may perform DL/UL switching and DL/UL transmission multiple times within the MCOT.

The values of X and Y may be defined by specifications or regulations or configured/indicated in advance by the BS.

In addition, the BS or UE may acquire a new COT again through LBT (e.g., Cat-3 LBT or Cat-4 LBT) without sharing a previously acquired COT. Then, the BS or UE may start DL/UL transmission based on the new COT. Alternatively, if the BS or UE performs and succeeds in Cat-2 LBT, the BS or UE may continue subsequent DL/UL transmission by sharing the COT within the MCOT. In this case, DL/UL switching may be allowed only once at most.

[Proposed Method #4] the BS May Configure/Indicate the Applicability of SCSe or the Type of LBT (e.g., Channel Access with/without LBT) for Each UL Signal/Channel (in Countries/Regions where LBT is Essential) to Allow UL Transmission.

### 1. Embodiment #4-1

The applicability of SCSe or the LBT type may be configured/indicated for each SRS resource set, each SRS resource obtained by grouping SRS resources in an SRS resource set, and/or each SRS resource through RRC layer signaling and/or DCI.

### 2. Embodiment #4-2

When CG-PUSCH resources are configured, the applicability of SCSe or the LBT type may be indicated/configured only through RRC layer signaling, or the applicability of SCSe or the LBT type may be configured/indicated through a combination of RRC layer signaling and activation DCI.

### 3. Embodiment #4-3

Regarding transmission of a PUCCH or a PUSCH without user plane data, the applicability of SCSe or the LBT type may be configured/indicated through RRC layer signaling and/or DCI.

The applicability of SCSe and/or the LBT type for the signals/channels may be configured cell-specifically or UE-specifically. If there are no separate configurations/indications, LBT or predefined/preconfigured operations may be performed by default, and each signal/channel may be transmitted. In this case, the duty cycle restriction regarding SCSe may vary depending on national/regional regulations. The duty cycle restriction may have a predetermined value or predefined/preconfigured.

Depending on the country/region, the implementation of a spectrum sharing mechanism such as LBT may be mandatory, or channel access may be possible without LBT. In regions where channel access is possible without LBT, immediate transmission may be performed based on the no-LBT mode, but in regions where the implementation of LBT is mandatory, both the BS and UE need to successfully perform LBT before starting DL/UL transmission.

However, for signals/channels where the transmission length of control information or management information (e.g., ACK/NACK, synchronization signal, beam management signal, etc.) satisfies the duty cycle conditions (for example, when the transmission length is less than 10% within 100 ms) within a specific observation period, transmission without LBT may be permitted by applying SCSe even in the regions where LBT is mandatory, depending on the regulations.

Therefore, SCSe may be applied for each signal/channel based on the configurations of the BS, allowing DL/UL transmission to be performed without LBT. In other cases, DL/UL transmission may be performed after LBT because the application of SCSe is not allowed. In this case, the BS may configure/indicate to the UE the applicability of SCSe or the LBT type (e.g., LBT mode or no-LBT mode) for each UL signal/channel through RRC layer signaling and/or DCI, and the UE may perform UL transmission by applying SCSe or LBT before transmitting each UL signal/channel according to the configurations/indications of the BS.

The UE may apply SCSe always based on the configurations/indications of the BS. Thus, when it is configured/indicated by the BS that the UE is capable of applying SCSe, the UE may perform UL transmission by applying SCSe on the assumption that the corresponding UL transmission satisfies the duty cycle. Alternatively, when the UE is configured/instructed to perform SCSe, the UE may autonomously calculate the duty cycle. If the corresponding UL transmission satisfies the duty cycle restriction, the UE may apply SCSe. If the corresponding UL transmission does not satisfy the duty cycle restriction, the UE may perform LBT. If it is determined that the channel is idle, the UE may perform UL transmission based on the determination.

When the UE receives a sounding reference signal (SRS) resource set from the BS, the UE may apply SCSe or LBT for each SRS resource set. In this case, SRS resource sets where transmission is allowed without LBT and SRS resource sets where LBT is mandatory for transmission may be configured separately. If the UE is configured with a specific SRS resource set where the UE is capable applying SCSe, the UE may perform SRS transmission on all SRS resources included in the corresponding SRS resource set without performing the LBT operation. In other words, the UE does not need to perform LBT before performing the SRS transmission on all SRS resources included in the corresponding SRS resource set.

In this case, the UE may assume that SCSe configured by the BS satisfies the duty cycle for an SRS resource set where SCSe is configured and then transmit an SRS by applying SCSe. In addition, even if SCSe is configured, the UE may autonomously determine whether the duty cycle conditions are satisfied. If it is determined that the duty cycle is satisfied, the UE may perform transmission by applying SCSe to the SRS resource set that satisfies the duty cycle. If the SRS resource set does not satisfy the duty cycle, the UE may perform transmission on the SRS resource set after performing LBT.

There may be an SRS resource set to which SCSe is not possible among a plurality of SRS resource sets configured for the UE. In this case, the UE may perform LBT before transmitting an SRS on SRS resources included in the corresponding SRS resource set. When the UE succeeds in LBT (for example, when the channel is determined to be idle), the UE may start the corresponding SRS transmission. In addition, the applicability of SCSe or the LBT type may be configured/indicated for each SRS resource or each SRS resource group, which is obtained by grouping SRS resources in an SRS resource set, rather than the SRS resource set. In this case, SRS transmission may be performed by applying SCSe and/or LBT in the same way as described above.

The BS may configure/indicate the applicability of SCSe or the LBT type when configuring a CG-PUSCH to the UE. There are two types of CG resources: Type 1 CG resources, which are configured only through RRC layer signaling, and Type 2 CG resources, which are indicated by a combination of RRC layer signaling and DCI. CG resources include Type 1 CG resources, which are configured only through RRC layer signaling, and Type 2 CG resources, which are indicated by a combination of RRC layer signaling and DCI. In the case of Type 1 CG resources, when CG resources are configured through RRC layer signaling, the applicability of SCSe and/or the LBT type (e.g., LBT mode or no-LBT mode) may be configured together. In the case of Type 2 CG resources, when CG resources are configured through RRC layer signaling, the applicability of SCSe and/or the LBT type may be configured together similarly to Type 2 CG resources. However, in some cases, the applicability of SCSe and/or the LBT type may be indicated in combination with activation DCI. For example, a field for indicating the applicability of SCSe and/or the LBT type may be included in the activation DCI. When the BS configures/indicates SCSe for CG-PUSCH transmission, and when the UE is configured with SCSe, the UE may assume that the corresponding CG-PUSCH satisfies the duty cycle and perform the CG-PUSCH transmission by applying SCSe at all times. Alternatively, even when the UE is configured/indicated with SCSe, the UE may autonomously determine whether the duty cycle restriction is satisfied. If it is determined that the duty cycle is satisfied, the UE may transmit the CG-PUSCH by applying SCSe. If the duty cycle is not satisfied, the UE may perform LBT and then start CG-PUSCH transmission.

For a PUCCH or PUSCH without user plane data (e.g., PUSCH containing only HARQ-ACK), the applicability of SCSe or the LBT type may be configured/indicated. For a PUCCH or a PUSCH without user plane data, when the applicability of SCSe or the LBT type is configured to the UE through higher layer signaling such as RRC layer signaling, and when the corresponding PUCCH or PUSCH transmission is triggered by DCI, the UE may perform UL transmission without LBT by applying SCSe at all times. When it is configured to the UE that SCSe is not allowed or if the applicability of SCSe is not configured to the UE, the UE may always perform LBT before transmitting the PUCCH or PUSCH. Only when LBT is successful (for example, the channel is determined to be IDLE), the UE may start UL transmission. Even in this case, if SCSe is configured/instructed from the BS, the UE may perform the PUCCH/PUSCH transmission without LBT by assuming that a UL signal corresponding to SCSe satisfies the duty cycle. Alternatively, even if the UE is allowed to apply SCSe, the UE may autonomously check whether the duty cycle restriction is satisfied. Then, the UE may determine whether to perform UL transmission without LBT or to perform UL transmission after performing LBT.

On the other hand, if the LBT type for UL signals/channels is configured/indicated to the UE as the no-LBT mode, the UE may assume that transmission of the corresponding UL signals/channels is always possible without LBT, regardless of the duty cycle. For example, if the LBT type is configured/indicated as the no-LBT mode, the UE may perform UL transmission without LBT. Additionally, SCSe may be applied even when the LBT type is set to the LBT mode.

Meanwhile, the applicability of SCSe and/or the LBT type for UL signals/channels may be configured cell-specifically or UE-specifically. If there are no separate configurations/indications, LBT may be performed by default, or each UL signal/channel may be transmitted after performing predefined/preconfigured operations. In this case, the duty cycle restriction regarding SCSe may vary depending on national/regional regulations. The duty cycle restriction may have a predefined value or determined/configured in advance.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

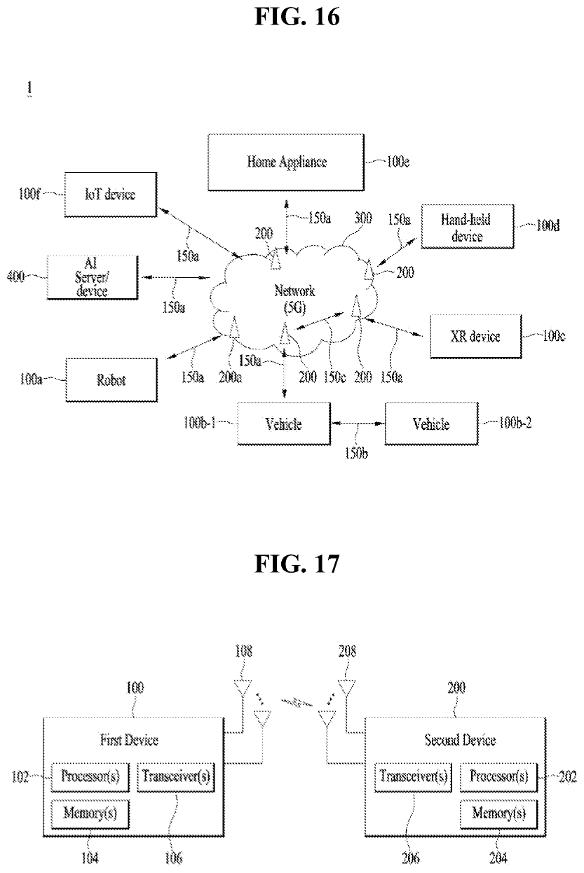

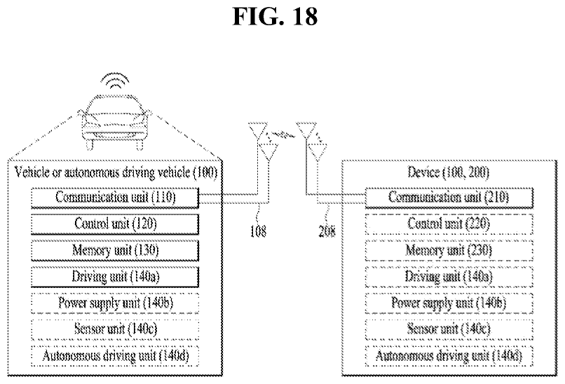

FIG. 16 illustrates a communication system 1 applied to the present disclosure. Referring to FIG. 16, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An A1 technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

FIG. 17 illustrates wireless devices applicable to the present disclosure.

Referring to FIG. 17, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor(s) 102 of the first wireless device 100 and stored in the memory(s) 104 of the first wireless device 100, according to an embodiment of the present disclosure will be described.

Although the following operations will be described based on a control operation of the processor(s) 102 in terms of the processor(s) 102, software code for performing such an operation may be stored in the memory(s) 104. For example, in the present disclosure, the at least one memory(s) 104 may be a computer-readable storage medium and store instructions or programs. The instructions or programs may cause, when executed, the at least one processor operably connected to the at least one memory to perform operations according to embodiments or implementations of the present disclosure, related to the following operations.

For example, the processor(s) 102 may determine an LBT mode and/or LBT type. In addition, a method by which the processor(s) 102 determines the LBT mode and/or LBT type may be based on [Proposed Method #1] and/or [Proposed Method #4].

The processor(s) 102 may perform LBT based on the LBT mode and/or LBT type. For example, if the LBT mode and/or LBT type is determined to be the no-LBT mode, the processor(s) 102 may omit performing LBT. If the LBT mode and/or LBT type is determined to be the LBT mode, the processor(s) 102 may perform LBT to determine whether a related channel and/or beam direction is idle.

The processor(s) 102 may transmit a UL/DL signal through the transceiver(s) 106 without LBT. Alternatively, after performing LBT, the processor(s) 102 may transmit a UL signal through the transceiver(s) 106 based on the determination that the related channel and/or beam direction is idle.

For example, transmission of a UL signal based on or without LBT may be based on at least one of [Proposed Method #2] to [Proposed Method #4].

The processor(s) 102 may receive a DL signal transmitted by the BS according to the determined/indicated/configured LBT mode and/or LBT type through the transceiver(s) 106. For example, the processor(s) 102 may receive a DL signal through the transceiver(s) 106 based on at least one of [Proposed Method #2] to [Proposed Method #4].

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor(s) 202 of the second wireless device 100 and stored in the memory(s) 204 of the second wireless device 200, according to an embodiment of the present disclosure will be described.

Although the following operations will be described based on a control operation of the processor(s) 202 in terms of the processor(s) 202, software code for performing such an operation may be stored in the memory(s) 204. For example, in the present disclosure, the at least one memory(s) 204 may be a computer-readable storage medium and store instructions or programs. The instructions or programs may cause, when executed, the at least one processor operably connected to the at least one memory to perform operations according to embodiments or implementations of the present disclosure, related to the following operations.

For example, the processor(s) 202 may determine an LBT mode and/or LBT type. In addition, a method by which the processor(s) 202 determines the LBT mode and/or LBT type may be based on [Proposed Method #1] and/or [Proposed Method #4].

The processor(s) 202 may perform LBT based on the LBT mode and/or LBT type. For example, if the LBT mode and/or LBT type is determined to be the no-LBT mode, the processor(s) 202 may omit performing LBT. If the LBT mode and/or LBT type is determined to be the LBT mode, the processor(s) 202 may perform LBT to determine whether a related channel and/or beam direction is idle.

The processor(s) 202 may transmit a DL signal through the transceiver(s) 206 without LBT. Alternatively, after performing LBT, the processor(s) 202 may transmit a DL signal through the transceiver(s) 206 based on the determination that the related channel and/or beam direction is idle.

For example, transmission of a DL signal based on or without LBT may be based on at least one of [Proposed Method #2] to [Proposed Method #4].

The processor(s) 202 may transmit information for indicating/configuring the LBT mode and/or LBT type to the UE through the transceiver(s) 206. For example, the information that the processor(s) 202 transmits through the transceiver(s) 206 may be based on [Proposed Method #1] and/or [Proposed Method #4].

However, if the UE autonomously determines the LBT mode and/or LBT type for UL transmission without indications/configurations of the processor(s) 202, the process in which the processor(s) 202 transmits the above-described information through the transceiver(s) 206 may be omitted.

The processor(s) 202 may receive a UL signal transmitted according to the determined/indicated/configured LBT mode and/or LBT type through the transceiver(s) 206 (S1303). For example, the processor(s) 202 may receive a UL signal through the transceiver 206 based on at least one of [Proposed Method #2] to [Proposed Method #4].

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

FIG. 28 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 28, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

While the above-described method of transmitting and receiving a UL/DL signal and an apparatus therefor have been described based on an example applied to a 5G NR system, the method and apparatus are applicable to various wireless communication systems in addition to the 5G NR system.

What is claimed is:

1. A method of transmitting, by a user equipment (UE), a first message of a random access procedure in a wireless communication system, the method comprising:
receiving first information regarding a configuration of the random access procedure;
obtaining second information regarding a plurality of transmission occasions for transmission of the first message based on the first information;
determining an observation period based on a reference point related to the observation period; and
transmitting the first message on a transmission occasion within a period corresponding to a duty cycle of the observation period among the plurality of transmission occasions without channel sensing,
wherein the reference point is configured based on a specific system frame number (SFN) or a specific slot.

2. The method of claim 1, wherein based on that all of the plurality of transmission occasions within the observation period are included in the duty cycle, the first message is transmitted without the channel sensing.

3. The method of claim 1, wherein based on that the transmission occasion for the first message is not included in the duty cycle, the first message is transmitted after performing the channel sensing.

4. The method of claim 1, wherein based on that information regarding the reference point is not received, the reference point is set to an SFN with index 0.

5. The method of claim 1, wherein based on that the transmission occasion for the first message is not included in the duty cycle, the transmission of the first message is dropped.

6. The method of claim 1, wherein the first message is a message 1 (Msg 1) or a message A (Msg A), and
wherein the transmission occasion is a random access channel (RACH) occasion for the Msg 1, a RACH occasion for the Msg A, or a physical uplink shared channel (PUSCH) occasion for the Msg A.

7. A user equipment (UE) configured to transmit a first message of a random access procedure in a wireless communication system, the UE comprising:
at least one transceiver;
at least one processor; and
at least one memory operably connected to the at least one processor and configured to store instructions that, when executed, cause the at least one processor to perform operations comprising:
receiving first information regarding a configuration of the random access procedure through the at least one transceiver;
obtaining second information regarding a plurality of transmission occasions for transmission of the first message based on the first information;
determining an observation period based on a reference point related to the observation period; and
transmitting the first message on a transmission occasion within a period corresponding to a duty cycle of the observation period among the plurality of transmission occasions through the at least one transceiver without channel sensing,
wherein the reference point is configured based on a specific system frame number (SFN) or a specific slot.

8. The UE of claim 7, wherein based on that all of the plurality of transmission occasions within the observation period are included in the duty cycle, the first message is transmitted without the channel sensing.

9. The UE of claim 7, wherein based on that the transmission occasion for the first message is not included in the duty cycle, the first message is transmitted after performing the channel sensing.

10. The UE of claim 7, wherein based on that information regarding the reference point is not received, the reference point is set to an SFN with index 0

11. The UE of claim 7, wherein based on that the transmission occasion for the first message is not included in the duty cycle, the transmission of the first message is dropped.

12. The UE of claim 7, wherein the first message is a message 1 (Msg 1) or a message A (Msg A), and
wherein the transmission occasion is a random access channel (RACH) occasion for the Msg 1, a RACH occasion for the Msg A, or a physical uplink shared channel (PUSCH) occasion for the Msg A.

13. An apparatus configured to transmit a first message of a random access procedure in a wireless communication system, the apparatus comprising:
at least one processor; and
at least one memory operably connected to the at least one processor and configured to store instructions that, when executed, cause the at least one processor to perform operations comprising:
receiving first information regarding a configuration of the random access procedure;
obtaining second information regarding a plurality of transmission occasions for transmission of the first message based on the first information;
determining an observation period based on a reference point related to the observation period; and
transmitting the first message on a transmission occasion within a period corresponding to a duty cycle of the observation period among the plurality of transmission occasions without channel sensing,
wherein the reference point is configured based on a specific system frame number (SFN) or a specific slot.

14. A computer-readable storage medium comprising at least one computer program that causes at least one processor to perform operations comprising:
receiving first information regarding a configuration of the random access procedure;
obtaining second information regarding a plurality of transmission occasions for transmission of the first message based on the first information;
determining an observation period based on a reference point related to the observation period; and
transmitting the first message on a transmission occasion within a period corresponding to a duty cycle of the observation period among the plurality of transmission occasions without channel sensing,
wherein the reference point is configured based on a specific system frame number (SFN) or a specific slot.
